(19) United States
(12) Patent Application Publication
(10) Pub. No.: US 2026/0005595 A1
(43) Pub. Date: Jan. 1, 2026

(54) HYBRID DC-DC CONVERTER

(71) Applicant: EPIC Microsystems Inc., Santa Clara, CA (US)

(72) Inventors: Sorin Laurentiu Negru, San Jose, CA (US); Sabin Eftimie, Morgan Hill, CA (US)

(21) Appl. No.: 19/249,655

(22) Filed: Jun. 25, 2025

Related U.S. Application Data
(60) Provisional application No. 63/664,716, filed on Jun. 26, 2024.

(51) Int. Cl. H02M 1/00; H02M 3/158

(52) U.S. Cl. CPC H02M 1/0095; H02M 3/158

(57) ABSTRACT

Hybrid DC-DC converters are described. One aspect is an electrical circuit configured to perform a DC-DC voltage conversion between an input voltage and an output voltage. The electrical circuit may include a first electrical network connected between an input node and an output node. The first electrical network may include eight switching transistors, with six of the eight switching transistors being cross-coupled. The electrical circuit may further include a second electrical network connected between a switching node and a ground node, and six flying capacitors connected between the first electrical network and the second electrical network. The electrical circuit may also include an inductor connected between the switching node and the output node. In an aspect, the DC-DC voltage conversion involves a repeated cycle of four distinct switching system states, with each switching system state being associated with a distinct electric current path through the electrical circuit.

This application claims the priority benefit of provisional patent application No. 63/664,716 titled “Quad Current Path Hybrid Converter” filed on Jun. 26, 2024, the disclosure of which is incorporated by reference herein in its entirety.

### BACKGROUND

### Technical Field

The systems and methods described herein relate to hybrid electrical circuits that are configured to implement power-efficient, high-voltage DC to DC conversion.

### Background Art

The need for more electrical power in current applications has pushed the design of power converters towards its limits. From a small gadget like a smart watch to the big room of a data center, power conversion is used everywhere. Generally speaking, the main sources of electrical power are the “grid” (110V/60 Hz) and the “battery” (1.2V-18V). In most applications, electrical power needs to be converted from a first voltage level to a second voltage level. For example, 110V/60 Hz AC power sourced from the electrical grid may need to be converted to 5V DC power. With ever-increasing electrical power consumption in our lives, efficient power conversion techniques are important to implement.

Power conversion devices with low conversion efficiency may generate heat due to the associated inefficient power conversion. A smart watch, phone, laptop, tablet, or any other personal computing device running at a temperature of 60 degrees Celsius is not a comfortable gadget for a user. A server room of a data center with an ambient temperature of 40 degrees Celsius is also an uncomfortable environment. For years, power conversion efficiency has been an important feature of the electrical power conversion process, and is especially important in today's day and age.

Electrical power conversion is achieved with electrical converters. Based upon input and output time-dependent current/voltage, there are 4 basic types of converters: AC to AC, AC to DC, DC to DC, and DC to AC. They cover all combinations between alternating current (AC) and constant/direct current (DC) conversion. All battery applications (e.g., mobile phones, tablets, laptops, etc.) use DC to DC converters for inside supply rails and AC to DC converters for charging the respective rechargeable battery from a wall adapter. While a high efficiency power converter helps keep the devices cool, the battery also needs to be charged fast, with more power, from an AC/DC adapter. This requires a high charging current through the adapter cable. The associated heating limits the current through the cable to a maximum of 3 A. However, at such input current, the battery cannot charge fast enough in a short time.

In order to provide high current for charging but low current through the cable of the adapter, the input voltage of the converter (or output voltage of the adapter) needs to be increased. This requires a high input voltage DC/DC converter to supply the internal rails and a high output voltage AC/DC converter to supply the battery charging. A typical such DC/DC converter has 16V-28V/3A as input voltage, (coming through a cable from a wall adaptor) and 4.5V/10A-20A as output (the battery) voltage.

The current generation of AI-based computing systems require a different power delivery system. The microprocessors of an AI-based computing system might need up to 1000 A at 0.6V. Such AI-based computing systems may populate data centers. The required power cannot be delivered by a battery; such power is sourced directly from the industrial grid through one or more conversion stages. The first is almost always an AC/DC conversion from 110V AC to 48V DC. From 48V down to 0.6V there are a few conversion stages, done by DC/DC converters. Some of these DC voltage converters are high voltage converters, while some are low voltage converters. Therefore, a high voltage DC/DC converter will satisfy both battery and grid supply systems.

Such converters are important in today's power management systems. Existing power conversion systems such as buck converters are vulnerable to power loss. Buck converters can generate a lot of current but with a power conversion efficiency no greater than 85%. The power efficiency of these systems can be increased by splitting the output into multiple channels (e.g., 100 channels) connected in parallel, with each channel supplying a relatively small amount of current. Because each channel requires an inductor, a printed circuit board (PCB) area occupied by such a system will be prohibitive. Other approaches use charge-pump converters (with a fixed conversion ratio (CR)). Although charge-pump converters can reach 99% efficiency, they are not used for output currents in excess of 2 A. Hence, for the new generation of power-hungry systems, contemporary approaches that use buck converters or charge-pump converters are not suitable.

### SUMMARY

Aspects of the invention are directed to electrical circuits configured to implement power-efficient DC-to-DC power conversion. One aspect includes an electrical circuit configured to perform a DC-DC voltage conversion between an input voltage Vᵢₙ and an output voltage Vₒᵤₜ. The electrical circuit may be comprised of a first electrical network connected between an input node associated with the input voltage and an output node associated with the output voltage. The first electrical network may include eight switching transistors, with six of the eight switching transistors being cross-coupled.

The electrical circuit may include a second electrical network connected between a switching node and a ground node. The second electrical network may be comprised of six flying capacitors connected between the first electrical network and the second electrical network, and an inductor connected between the switching node and the output node.

In one aspect, the DC-DC voltage conversion involves a repeated cycle of four distinct switching system states. Each switching system state may be associated with a distinct electric current path through the electrical circuit.

In one aspect, there exists a direct path for an electric current between the input node and the output node. The direct path may include only switching transistor(s).

The electric current may flow through at least one switching transistor.

Any electric current path between the switching node and the input node may include at least one flying capacitor of the flying capacitors. In one aspect, there is at least one switching transistor connected to the output node.

In an aspect, an electric current flowing through the inductor bypasses at least one switching transistor connected directly to the output node in at least one of the switching system states.

An embodiment of the electrical circuit may include the electrical circuit being of a symmetrical topology/configuration.

In an aspect, the four distinct switching system states are comprised of a first magnetization system state, a demagnetization system state, a second magnetization system state, and the demagnetization system state.

In one aspect, the electrical circuit supports one of two modes of operation:
A first mode, where the output voltage and the input voltage are related by an inequality 4Vₒᵤₜ<Vᵢₙ, and
A resonant mode, where the output voltage and the input voltage are related by an equality 4Vₒᵤₜ=Vᵢₙ.

A respective pre-bias voltage of each flying capacitor may be independent of the mode of operation.

In one aspect, there may exist four distinct current paths for an electric current flowing through the electrical circuit. At least one current path enables a corresponding electric current to flow directly to the output node while bypassing the inductor.

The flying capacitors may be configured to be pre-charged at respective preset voltage levels.

In one aspect, at least one electric current path through the electrical circuit includes the electric current flowing through the first electrical network, the second electrical network, and the inductor.

In an aspect, the second electrical network comprises four switching transistors. Each system state may be associated with a combination of each of the eight switching transistors in the first electrical network and each of the four switching transistors in the second electrical network being in an on state or an off state.

Each flying capacitor may connect a transistor terminal connection node in the first electrical network and a transistor terminal connection node in the second electrical network.

For example, a first flying capacitor of the flying capacitors may connect a transistor terminal connection node between switching transistors Q1 and Q2 in the first electrical network to a transistor terminal connection node between switching transistors Q5 and Q6 in the second electrical network. A second flying capacitor of the flying capacitors may connect a transistor terminal connection node between switching transistors Q3 and Q8 in the first electrical network to a transistor terminal connection node between switching transistors Q5 and Q6 in the second electrical network. A third flying capacitor of the flying capacitors may connect a transistor terminal connection node between switching transistors Q4 and Q9 in the first electrical network to a transistor terminal connection node between switching transistors Q5 and Q6 in the second electrical network. A fourth flying capacitor of the flying capacitors may connect a transistor terminal connection node between switching transistors Q7 and Q8 in the first electrical network to a transistor terminal connection node between switching transistors Q11 and Q12 in the second electrical network. A fifth flying capacitor of the flying capacitors may connect a transistor terminal connection node between switching transistors Q2 and Q9 in the first electrical network to a transistor terminal connection node between switching transistors Q11 and Q12 in the second electrical network. A sixth flying capacitor of the flying capacitors may connect a transistor terminal connection node between switching transistors Q3 and Q10 in the first electrical network to a transistor terminal connection node between switching transistors Q11 and Q12 in the second electrical network.

In one aspect, a preset voltage on each of the first and fourth flying capacitors is

$$\frac{2 {V}_{in} + {V}_{out}}{3} ,$$

a preset voltage on each of the second and fifth flying capacitors is

$$\frac{{V}_{in} + 2 {V}_{out}}{3} ,$$

and a preset voltage on each of the third and sixth flying capacitors is Vₒᵤₜ.

An aspect may include an additional four switching transistors included in the lower electrical network in a symmetrical configuration to provide a modified electrical circuit.

Such a modified electrical circuit may support a mode of operation such that the output voltage and the input voltage may be related by an inequality

$$\frac{5}{2} {V}_{out} < {V}_{in} < 4 {V}_{out}$$

in this mode. In this case, the four distinct switching cycles of the modified electrical circuit are comprised of a first magnetization system state, a first demagnetization system state, a second magnetization system state, and a second demagnetization system state. Furthermore, each flying capacitor in the modified electrical circuit may connect a transistor terminal connection node in the first electrical network and a transistor terminal connection node in the second electrical network. For example, a first flying capacitor of the flying capacitors may connect a transistor terminal connection node between switching transistors Q1 and Q2 in the first electrical network to a transistor terminal connection node between switching transistors Q13 and Q14 in the second electrical network. A second flying capacitor of the flying capacitors may connect a transistor terminal connection node between switching transistors Q3 and Q8 in the first electrical network to a transistor terminal connection node between switching transistors Q6 and Q13 in the second electrical network. A third flying capacitor of the flying capacitors may connect a transistor terminal connection node between switching transistors Q4 and Q9 in the first electrical network to a transistor terminal connection node between switching transistors Q5 and Q6 in the second electrical network. A fourth flying capacitor of the flying capacitors may connect a transistor terminal connection node between switching transistors Q7 and Q8 in the first electrical network to a transistor terminal connection node between switching transistors Q15 and Q16 in the second electrical network. A fifth flying capacitor of the flying capacitors may connect a transistor terminal connection node between switching transistors Q2 and Q9 in the first electrical network to a transistor terminal connection node between switching transistors Q12 and Q15 in the second electrical network. A sixth flying capacitor of the flying capacitors may connect a transistor terminal connection node between switching transistors Q3 and Q10 in the first electrical network to a transistor terminal connection node between switching transistors Q11 and Q12 in the second electrical network.

In the modified electrical circuit, a preset voltage on each of the first and fourth flying capacitors is

$$\frac{2 {V}_{i n} + {V}_{o u t}}{3} ,$$

a preset voltage on each of the second and fifth flying capacitors is

$$\frac{{V}_{i n} + 2 {V}_{o u t}}{3} ,$$

and a preset voltage on each of the third and sixth flying capacitors is Vₒᵤₜ.

In an embodiment switching transistors Q6 and Q12 of the modified electrical circuit are replaced by electrical wires, thereby enabling switching transistors Q5 and Q13 to be directly connected at a transistor terminal connection node, and switching transistors Q11 and Q15 to be directly connected at a transistor terminal connection node, for a total of six switching transistors in the second electrical network.

In the modified electrical circuit, two additional switching transistors may be included in the first electrical network in a symmetrical configuration to provide a second modified electrical circuit. The second modified electrical circuit may support a mode of operation in which the output voltage and the input voltage are related by an inequality

$${V}_{out} < {V}_{i n} < \frac{5}{2} {V}_{out}$$

in this mode.

In an aspect, the original electrical circuit topology may further include an additional four switching transistors in the second electrical network in a symmetrical configuration, to provide a third modified electrical circuit. The third modified electrical circuit may support a resonant mode of operation in which the output voltage and the input voltage are related by an inequality

$${V}_{i n} = \frac{5}{2} {V}_{out}$$

in this mode.

Another aspect includes an electrical circuit configured to perform a DC-DC voltage conversion between an input voltage Vᵢₙ and an output voltage Vₒᵤₜ. The electrical circuit may include a first electrical network connected between an input node associated with the input voltage and an output node associated with the output voltage, the first electrical network including ten switching transistors. In an aspect, six of the ten switching transistors are cross-coupled. The electrical circuit may include a second electrical network connected between a switching node and a ground node. In an aspect, the second electrical network includes ten switching transistors. The electrical circuit may further include six flying capacitors connected between the first electrical network and the second electrical network, and an inductor connected between the switching node and the output node. The DC-DC voltage conversion may involve a repeated cycle of four distinct switching system states. Each switching system state may be associated with a distinct electric current path through the electrical circuit.

In one aspect, continuously turning on two switching transistors in the first electrical network and six switching transistors in the second electrical network implements an electrical circuit that supports a mode of operation that is one of two modes of operation:
A first mode, where the output voltage and the input voltage are related by an inequality 4Vₒᵤₜ<Vᵢₙ, and
A resonant mode, where the output voltage and the input voltage are related by an equality 4Vₒᵤₜ=Vᵢₙ.

In an aspect, continuously turning on two switching transistors in the first electrical network and four switching transistors in the second electrical network implements an electrical circuit that supports a mode of operation where the output voltage and the input voltage are related by an inequality

$$\frac{5}{2} {V}_{out} < {V}_{i n} < 4 {V}_{out}$$

in this mode.

In an aspect, continuously turning on four switching transistors in the second electrical network implements an electrical circuit that supports a mode of operation where the output voltage and the input voltage are related by an inequality

$${V}_{out} < {V}_{i n} < \frac{5}{2} {V}_{out}$$

in this mode.

In an aspect, continuously turning on two switching transistors in the first electrical network implements an electrical circuit that supports a resonant mode of operation where the output voltage and the input voltage are related by an inequality

$${V}_{i n} = \frac{5}{2} {V}_{out}$$

in this mode.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a circuit diagram of a hybrid DC-DC converter.

FIG. 2 is a timing diagram depicting a plurality of electrical signals associated with an operation of a hybrid DC-DC converter.

FIG. 3 is a circuit diagram of a hybrid DC-DC converter depicting a magnetization state.

FIG. 4 is a circuit diagram of a hybrid DC-DC converter depicting a demagnetization state.

FIG. 5 is a circuit diagram of a hybrid DC-DC converter depicting a magnetization state.

FIG. 6 is a state flow diagram depicting switching system state transitions between magnetization states and a demagnetization state.

FIG. 7 is a circuit diagram of a hybrid DC-DC converter.

FIGS. 8A through 8D are circuit diagrams depicting a hybrid DC-DC converter in different switching system states.

FIG. 9 is a circuit diagram of a hybrid DC-DC converter.

FIGS. 10A through 10D are circuit diagrams depicting a hybrid DC-DC converter in different switching system states.

FIG. 11 is a timing diagram depicting a plurality of electrical signals associated with an operation of a hybrid DC-DC converter.

FIG. 12 is a circuit diagram of a hybrid DC-DC converter.

FIGS. 13A through 13D are circuit diagrams depicting a hybrid DC-DC converter in different switching system states.

FIG. 14 is a timing diagram depicting a plurality of electrical signals associated with an operation of a hybrid DC-DC converter.

FIGS. 15A and 15B depict different embodiments of a DC-DC hybrid converter configured to implement a resonant mode of operation.

FIG. 16 is a timing diagram depicting a plurality of electrical signals associated with an operation of a hybrid DC-DC converter in a resonant mode.

FIG. 17 is a circuit diagram of a hybrid DC-DC converter.

FIGS. 18A and 18B depict different embodiments of a DC-DC hybrid converter configured to implement a resonant mode of operation.

FIG. 19 is a timing diagram depicting a plurality of electrical signals associated with an operation of a hybrid DC-DC converter in a resonant mode.

FIG. 20 is a circuit diagram of a generalized hybrid DC-DC converter.

FIG. 21 is a schematic conversion diagram depicting an equivalence between two embodiments of a hybrid DC-DC converter.

FIG. 22 is a schematic conversion diagram depicting an equivalence between two embodiments of a hybrid DC-DC converter.

FIG. 23 is a schematic conversion diagram depicting an equivalence between two embodiments of a hybrid DC-DC converter.

FIG. 24 is a schematic conversion diagram depicting an equivalence between two embodiments of a hybrid DC-DC converter.

FIG. 25 is a graphical representation of different possible modes of operation associated with hybrid DC-DC conversion.

FIG. 26 is a graph of duty cycle versus conversion ratio for different kinds of DC-DC converters.

FIG. 27 is a graph of normalized inductor ripple current versus conversion ratio for different kinds of DC-DC converters.

FIG. 28 is a circuit diagram of a hybrid DC-DC converter.

FIG. 29 is a block diagram depicting a multiphase DC-DC conversion operation.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the systems and methods described herein are related to a hybrid DC/DC converter (also referred to herein as a “hybrid DC-DC converter”) working at a high conversion ratio (e.g., Vᵢₙ/Vₒᵤₜ≥4). Unlike a buck converter, which uses an inductor as an energy storage element or a charge pump which uses capacitors for storage of energy, a hybrid converter uses both inductors and capacitors for storage of energy. While functioning, the energy is transferred between these components, before being delivered to the output. The capacitors used for storage are called “flying” capacitors to separate them from those used for filtering (input, output). The inductor is used as a storage element. In one aspect, the flying capacitor is used as an energy storage element to implement multilevel converter properties.

One aspect includes a hybrid DC/DC converter working at a high conversion ratio, Vᵢₙ/Vₒᵤₜ≥4. Occupying the same silicon area as a buck converter on a semiconductor chip implementation, the hybrid DC/DC converter disclosed herein offers significantly better efficiency than a buck converter. One aspect uses a switching sequence configured to split the load current, first, in two parts: one is the inductor current, and the other is the capacitive current going directly into Vₒᵤₜ. Second, to further split the inductor current into multiple FET paths. Both actions generate less power losses than traditional buck converters and other hybrid converters.

Some embodiments can be implemented as an integrated circuit that uses the same silicon area as a buck converter, while offering significantly better efficiency than a buck converter. One aspect is an electrical circuit that includes a charge pump and a multi-level converter into a circuit topology. This topology may use a predefined switching sequence for one or more power field effect transistors (FETs) in the electrical circuit to reduce power loss(es) on the inductor and on the resistive paths of FETs.

The main goal of the predefined switching sequence is to split the load current, first, in two parts: one is the inductor current, and the other is the capacitive current going directly into an output voltage node, with a corresponding output voltage Vₒᵤₜ. The second split is associated with further splitting the inductor current into multiple paths that include FETs. Both actions generate less power losses than traditional buck converters and other hybrid converters.

Some embodiments are configured to perform high voltage (>16V) conversion to low voltage conversion (<1V) at high output current (>50A) on a relatively small PCB area.

Based on input voltage levels of the different embodiments of the hybrid DC-DC converters described herein, there are five modes of operation. For each mode of operation, a pre-bias voltage on each flying capacitor included in the different embodiments of the disclosed hybrid DC-DC converter stays at a constant value regardless of the mode of operation and the respective circuit topology of the respective embodiment.

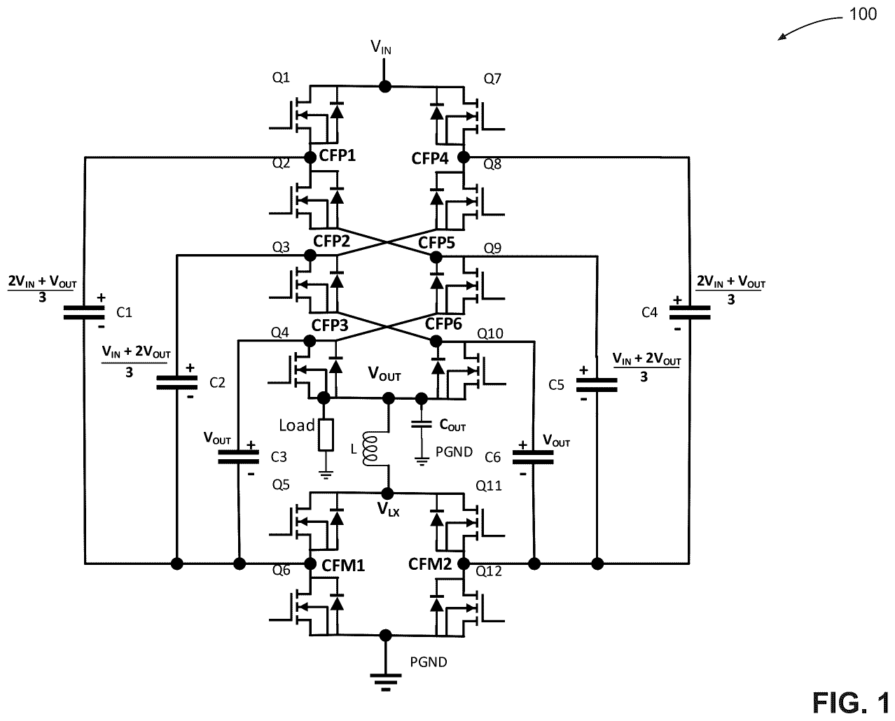

FIG. 1 is a circuit diagram of a hybrid DC-DC converter 100. As depicted, the hybrid DC-DC converter 100 includes an input node associated with an input voltage Vᵢₙ, an output node associated with an output voltage Vₒᵤₜ, and a switching node associated with a voltage V_{LX}. Hybrid DC-DC converter 100 also includes a first electrical network that includes eight switching transistors, Q1, Q2, Q3, Q4, Q7, Q8, Q9 and Q10. In one aspect, the first electrical network is connected between the input node and the output node. Further, as depicted in FIG. 1, six of the eight switching transistors Q1-Q8 are cross-coupled. In a particular embodiment, the cross-coupled switching transistors are:
Q2 and Q9,
Q3 and Q8,
Q3 and Q10, and
Q4 and Q9.

The hybrid DC-DC converter 100 may further include a second electrical network connected between the switching node and the output node. The second electrical network may include four switching transistors Q5, Q6, Q11 and Q12.

The hybrid DC-DC converter 100 may further six flying capacitors connected between the first electrical network and the second electrical network. In one aspect, each flying capacitor connects a transistor terminal connection node in the first electrical network and a transistor terminal connection node in the second electrical network. For example:
A first flying capacitor C1 connects a transistor terminal connection node between switching transistors Q1 and Q2 to a transistor terminal connection node between switching transistors Q5 and Q6,
A second flying capacitor C2 connects a transistor terminal connection node between switching transistors Q3 and Q8 to a transistor terminal connection node between switching transistors Q5 and Q6,
A third flying capacitor C3 connects a transistor terminal connection node between switching transistors Q4 and Q9 to a transistor terminal connection node between switching transistors Q5 and Q6,
A fourth flying capacitor C4 connects a transistor terminal connection node between switching transistors Q7 and Q8 to a transistor terminal connection node between switching transistors Q11 and Q12,
A fifth flying capacitor C5 connects a transistor terminal connection node between switching transistors Q2 and Q9 to a transistor terminal connection node between switching transistors Q11 and Q12, and
A sixth flying capacitor C6 connects a transistor terminal connection node between switching transistors Q3 and Q10 to a transistor terminal connection node between switching transistors Q11 and Q12.

The hybrid DC-DC converter 100 may also include an inductor L connected between the switching node and the output node. As depicted, the circuit topology of the hybrid DC-DC converter 100 is a symmetrical circuit topology.

In one aspect, the hybrid DC-DC converter 100 includes the following characteristics:
There exists a direct path for an electric current between the input node and the output node. This direct path may include only one or more of the switching transistors and no other circuit element.
The electric current passes through at least one switching transistor.
Any electric current path between the switching node and the input node includes at least one flying capacitor.
There is at least one switching transistor connected to the output node.
An electric current flowing through the inductor bypasses the at least one switching transistor connected directly to the output node in at least one of four distinct switching system states discussed herein.
There exist four distinct current paths for an electric current flowing through the electrical circuit. Of these four distinct current paths, at least one current path enables a corresponding electric current to flow directly to the output node while bypassing the inductor.
At least one electric current path includes the electric current flowing through the first electrical network, the second electrical network, and the inductor.

In one aspect and as depicted in FIG. 1, the flying capacitors are charged with the following preset voltages:
A preset voltage on each of C1 and C4 is

$$\frac{2 {V}_{i n} + {V}_{o u t}}{3} ,$$

A preset voltage on each of C2 and C5 is

$$\frac{{V}_{i n} + 2 {V}_{o u t}}{3} ,$$

and
A preset voltage on each of C3 and C6 is Vₒᵤₜ.

In an embodiment, switching transistors Q1-Q12 (and all other switching transistors described herein) are power NFETs. In general, the switching transistors described herein may be any kind of power switch, such as NFETs, PFETs, bipolar switches, thyristors, triacs, gallium nitride (GaN) devices, etc.

A load may be connected between the output node and a ground plane of hybrid DC-DC converter 100, as shown in FIG. 1. The output voltage to the load is Vₒᵤₜ. In this sense, hybrid DC-DC converter 100 could function as a power supply of a microprocessor, a resistor, a current source, etc.

During an operation of hybrid DC-DC converter 100, different combinations of switching transistors Q1-Q12 are switched on or off. In one aspect, the hybrid DC-DC converter 100 performs a DC-DC voltage conversion that involves a repeated cycle of four distinct switching system states. (A single cycle consists of the four distinct sequential switching system states.) In an aspect, each switching system state is associated with a distinct electric current path through the electrical circuit associated with hybrid DC-DC converter 100. Each system state is associated with a specific combination of switching transistors Q1-Q12 each being in an on (conducting) state or an off (non-conducting) state.

In an aspect, hybrid DC-DC converter 100 supports one of two modes of operation:
A first mode (M1), where the output voltage and the input voltage are related by an inequality 4Vₒᵤₜ<Vᵢₙ, and
A resonant mode (RM12), where the output voltage and the input voltage are related by an equality 4Vₒᵤₜ=Vᵢₙ.

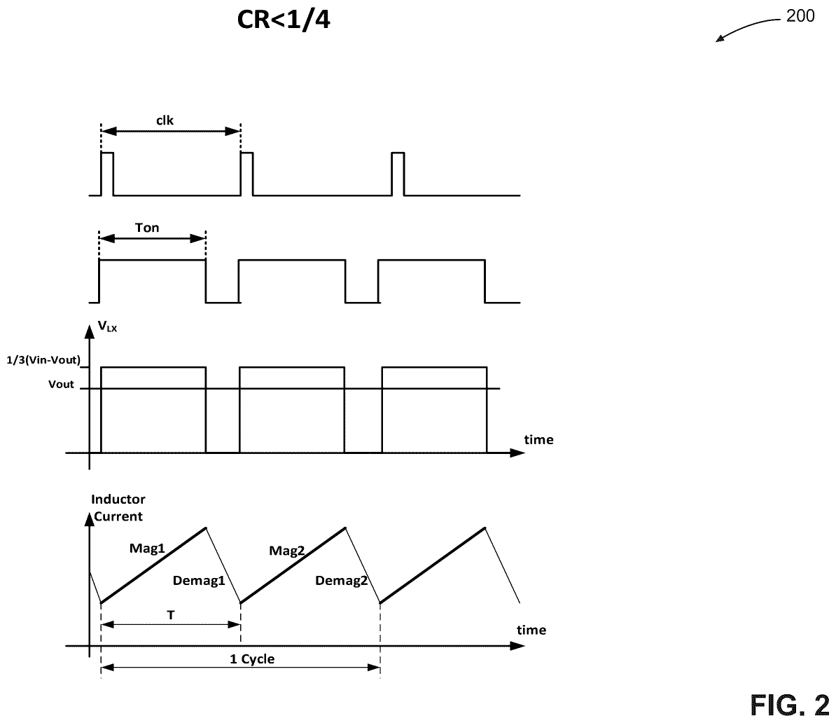

FIG. 2 is a timing diagram 200 depicting a plurality of electrical signals associated with an operation of hybrid DC-DC converter 100 for mode M1. Timing diagram 200 depicts electrical signal waveforms associated with the four distinct switching system states. A state is either initiated by a clock signal (shown as clk in timing diagram 200) and terminated by the falling edge of an associated T_{ON} signal, or, initiated by a falling edge of the T_{ON} signal and terminated by the clock signal. Both signals, clock (clk) and T_{ON}, are controlled by a feedback loop which regulates the output voltage. Timing diagram 200 also shows switching node voltage V_{LX} as a function of time. Timing diagram 200 also depicts a current waveform representing inductor current through inductor L versus time. As shown in the inductor current waveform, there are four distinct switching system states:
A first magnetization state (Magnetization1, or Mag1),
A first demagnetization state (Demagnetization1, or Demag1),
A second magnetization state (Magnetization2, or Mag2), and
A second demagnetization state (Demagnetization2, or Demag2).

As depicted in timing diagram 200, each combination of a single magnetization state and a consecutive demagnetization state (e.g., Mag1 and Demag1, or Mag2 and Demag2) is associated with a time period T. A full sequence of the four switching system states (i.e., Mag1 Demag1, Mag2 and Demag2) constitutes one switching cycle.

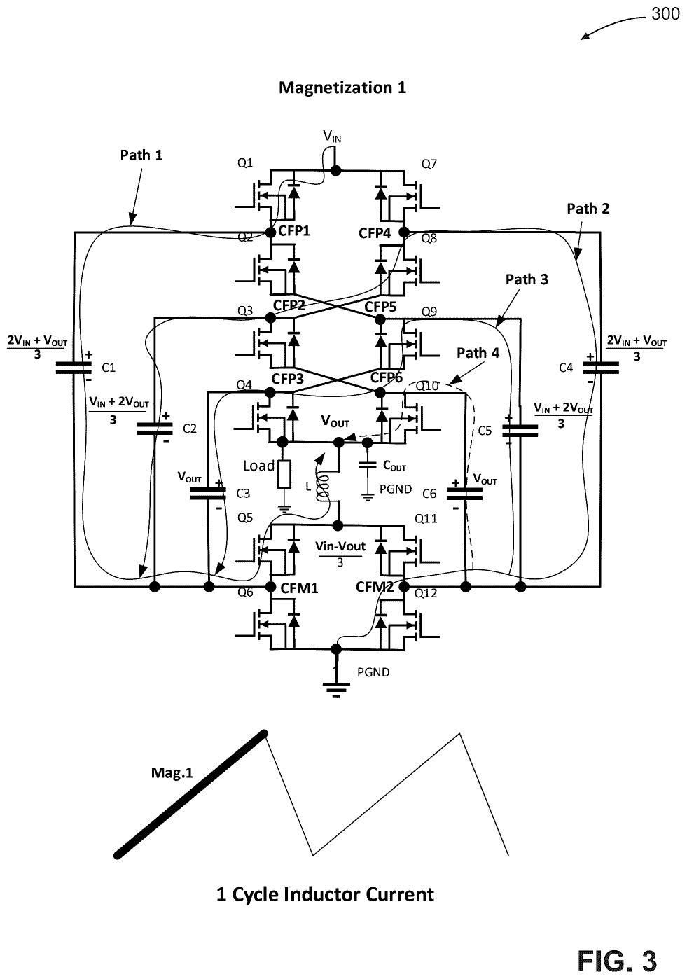

FIG. 3 is a circuit diagram of hybrid DC-DC converter 100 depicting a magnetization state 300. Magnetization state 300 is a switching system state that may be associated with magnetization state Mag1 for mode M1. In this magnetization state, the states of the switching transistors are:
ON: Q1, Q5, Q8, Q9, Q10, Q12
OFF: Q2, Q3, Q4, Q6, Q7, Q11

As a result of this configuration of ON/OFF switches and considering the voltages on each of flying capacitors mentioned before, the voltage on the inductor is:

$${V}_{L X} = \frac{1}{3} ( {V}_{i n} - {V}_{out} ) > {V}_{out} , Δ {V}_{L} > 0. \qquad ( 1 )$$

Because Vᵢₙ>4Vₒᵤₜ, such a voltage is positive, and the inductor L is magnetized. Hence, the magnetization state 300 is referred to as Mag1.

During the Mag1 switching system state (also referred to as “State 1”), four distinct electrical current paths for electrical currents flowing in the hybrid DC-DC converter 100 circuit can be identified:
Path1: Vᵢₙ→Q1→C1→Q5→Inductor L→Vₒᵤₜ
Path2: PGND→Q12→C4→Q8→C2→Q5→Inductor L→Vₒᵤₜ
Path3: PGND→Q12→C5→Q9→C3→Q5→Inductor L→Vₒᵤₜ
Path4: PGND→Q12→C6→Q10→Vₒᵤₜ

The electrical currents from these four electrical current paths gather into a “Quad Current Path” towards Vₒᵤₜ. Of these, three electrical current paths close through inductor L and one electrical current path goes directly to Vₒᵤₜ. A big difference from a traditional buck converter is Path4, which does not exist for a traditional buck converter. This is one of the reasons that hybrid DC-DC converter 100 has better efficiency as compared to a traditional buck converter.

During this Magnetization1 phase of the inductor L, flying capacitors change their states as well:
C1 is charged with ΔV1 by a fraction of inductor current I_{L}_{₁}.
C2 is charged with ΔV2 by a fraction of the inductor current I_{L}_{₂}.
C3 is charged with ΔV3 by a fraction of the inductor current I_{L}_{₃}.
C4 is discharged with ΔV1 by I_{L}_{₂}.
C5 is discharged with ΔV2 by I_{L}_{₃}.
C6 is discharged with ΔV3 by I_{CP} which is the difference between I_{LOAD} (current through the load) and I_{L} (current through the inductor L).

After the T_{ON} pulse has elapsed, the system changes state. The system goes to the next switching system state—State 2.

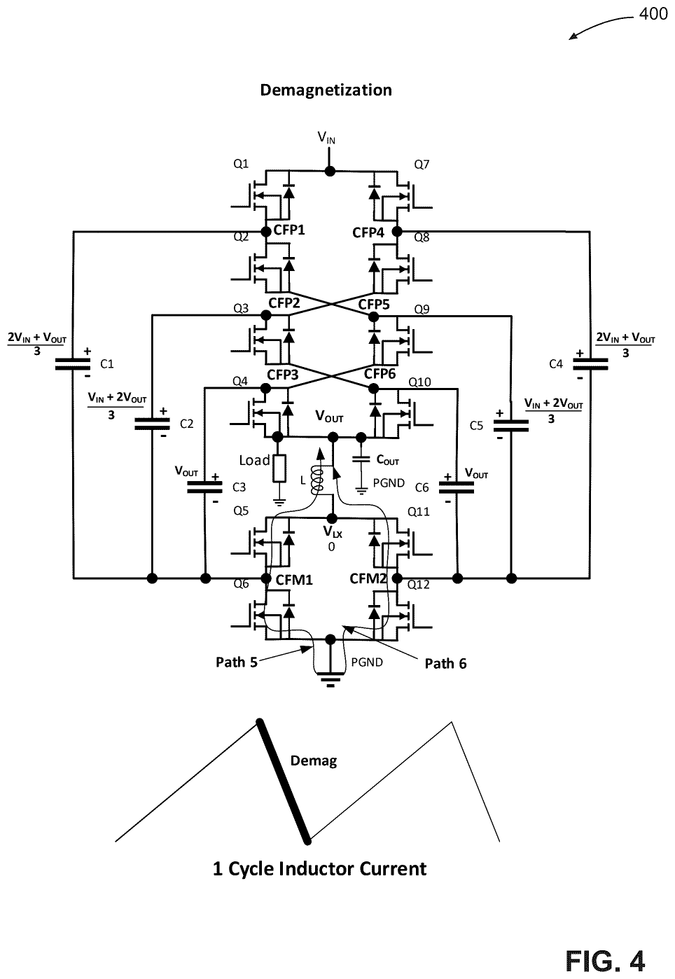

FIG. 4 is a circuit diagram of hybrid DC-DC converter 100 depicting a demagnetization state 400. Demagnetization state 400 is a switching system state that may be associated with demagnetization state Demag1 for mode M1. In an embodiment, demagnetization state 400 is also associated with demagnetization state Demag2 for mode M1. In other words, for the hybrid DC-DC converter 100, switching system states Demag1 and Demag2 are identical (also referred to as “Demag” or “State 2”) for mode M1. In this demagnetization state, the states of the switching transistors are:
ON: Q5, Q6, Q11, Q12
OFF: Q1, Q2, Q3, Q4, Q7, Q8, Q9, Q10.

The inductor voltage is:

$${V}_{L X} = 0 , Δ {V}_{L} = {V}_{L X} - {V}_{out} = - {V}_{out} . \qquad ( 2 )$$

Because of the negative voltage, the inductor is demagnetized. Therefore, this “State2” is called “Demag”, or a demagnetization state.

During the demagnetization state, two distinct electrical current paths for electrical currents flowing in the hybrid DC-DC converter 100 circuit can be identified:
Path5: PGND→Q6→Q5→Inductor L→Vₒᵤₜ
Path6: PGND→Q12→Q11→Inductor L→Vₒᵤₜ

During this demagnetization phase, the flying capacitors in hybrid DC-DC converter 100 do not change their states. There is no current flowing through these capacitors, so the voltages on each capacitor is the same as at the end of State1. At the second clock pulse, the system goes into “State3”.

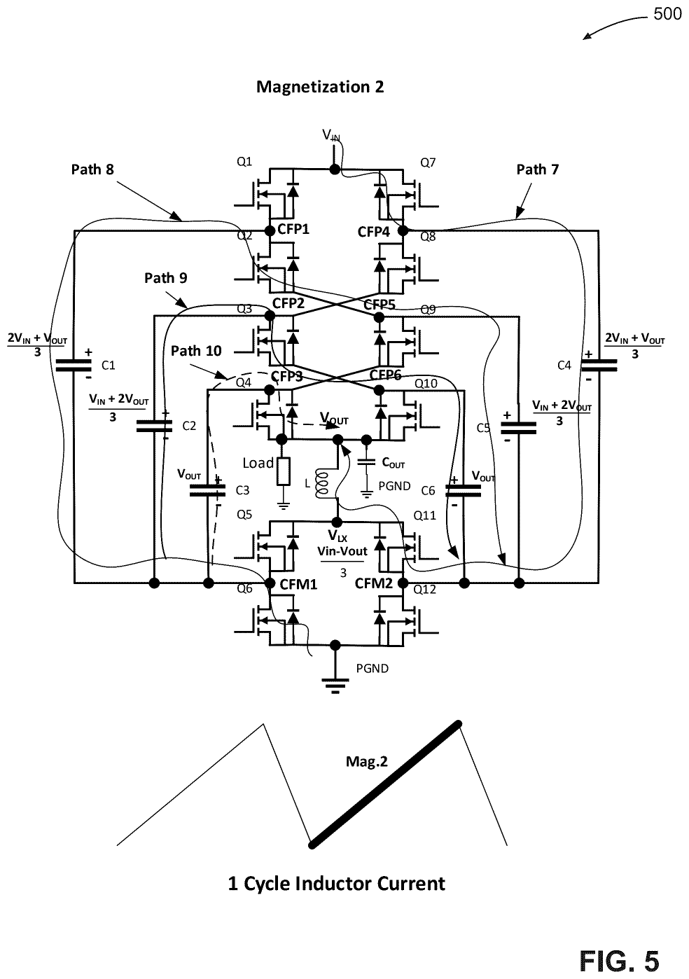

FIG. 5 is a circuit diagram of hybrid DC-DC converter 100 depicting a magnetization state 500. Magnetization state 500 is a switching system state that may be associated with magnetization state Mag2 for mode M1 for hybrid DC-DC converter 100. In this magnetization state, the states of the switching transistors are:
ON: Q2, Q3, Q4, Q6, Q7, Q11
OFF: Q1, Q5, Q8, Q9, Q10, Q12

We can identify 4 paths for currents circulating into the system:
Path7: Vᵢₙ→Q7→C4→Q11→Inductor L→Vₒᵤₜ
Path8: PGND→C1→Q2→C5→Q11→Inductor L→Vₒᵤₜ
Path9: PGND→C2→Q3→C6→Q11→Inductor L→Vₒᵤₜ
Path10: PGND→Q6→C3→Q4→Vₒᵤₜ

During this Mag2 phase of the inductor L, the flying capacitors change their states as well:
C1 is discharged with ΔV1 by a fraction of inductor current I_{L}_{₅}.
C2 is discharged with ΔV2 by a fraction of the inductor current I_{L}_{₆}.
C3 is discharged with ΔV3 by electrical current I_{CP} which is the difference between I_{LOAD} (current through the Load) and I_{L} (current through the inductor L).
C4 is charged with ΔV1 by I_{L}_{₄}.
C5 is charged with ΔV2 by I_{L}_{₅}.
C6 is charged with ΔV3 by I_{L}_{₆} which is the difference between I_{LOAD} (current through the Load) and I_{L} (current through the inductor L).

The equation associated with the switching system state Magnetization2 is the same as that used for the switching system state Magnetization1:

$${V}_{L X} = \frac{1}{3} ( {V}_{i n} - {V}_{out} ) > {V}_{out} , Δ {V}_{L} > 0. \qquad ( 3 )$$

After the T_{ON} pulse has elapsed, the system changes state. The system goes to the next switching system state-State 4. State 4 corresponds to the Demag2 state. In an aspect, the Demag2 state for hybrid DC-DC converter 100 is identical to the Demag1 state (i.e., the Demag state). The equations associated with this State 4 are the same as for State 2:

$${V}_{L X} = 0 , Δ {V}_{L} = {V}_{L X} - {V}_{out} = - {V}_{out} < 0. \qquad ( 4 )$$

During this state, the inductor is demagnetized. The end of State 4 coincides with the end of a cycle.

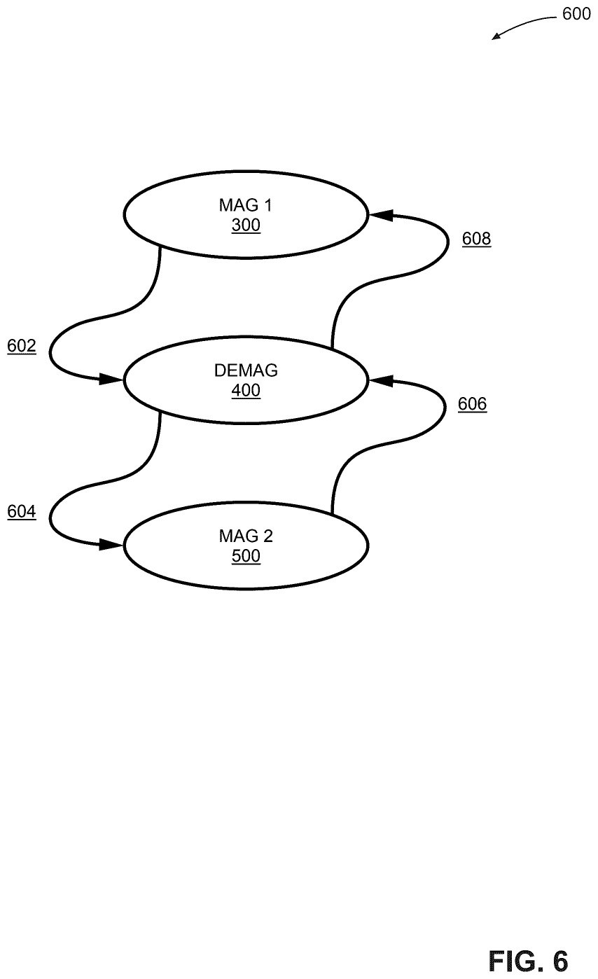

FIG. 6 is a state flow diagram 600 depicting switching system state transitions between magnetization states and a demagnetization state for the hybrid DC-DC converter 100 system. Starting at Mag1 state 300 (State 1), the system transitions 602 to Demag state 400 (State 2). After the Demag state 400, the system transitions 604 to the Mag2 state 500 (State 3). Finally, the system transitions 606 from Mag2 state 500 to the Demag state 400 (State 4). The end of State 4 marks the end of a single switching system state cycle. After the Demag state 400 (State 4), the system transitions back 608 to the Mag1 state 300 to start a new switching system state cycle. In an aspect, a switching system phase transitions to a subsequent switching system phase based on the input clock signal.

At the end of each switching system state cycle, the voltages on the flying capacitors should be equal to the corresponding values at the beginning of the cycle. Otherwise, the system will not work. This critical condition, to keep the flying capacitors well balanced, is achieved by the control feedback loop. Having all flying capacitors as being equal in value leads to the following equations:

$${I}_{{L}_{1}} = {I}_{{L}_{2}} = {I}_{{L}_{3}} = {I}_{{L}_{4}} = {I}_{{L}_{5}} = {I}_{{L}_{6}} = {I}_{C P} = 1 / 3 * {I}_{L}$$

$${I}_{L} = 3 / 4 * {I}_{L O A D}$$

$${I}_{C P} = 1 / 4 * {I}_{L O A D}$$

Tables 1 and 2 provide a summary of mode M1 functionality over 1 cycle (Mag1|Demag1|Mag2|Demag2|) for hybrid DC-DC converter 100:

TABLE 1
Transistor Switching States - Mode M1

| | Q1 | Q2 | Q3 | Q4 | Q5 | Q6 | Q7 | Q8 | Q9 | Q10 | Q11 | Q12 |
|---|---|---|---|---|---|---|---|---|---|---|---|---|
| Mag1 | ON | OFF | OFF | OFF | ON | OFF | OFF | ON | ON | ON | OFF | ON |
| Demag | OFF | OFF | OFF | OFF | ON | ON | OFF | OFF | OFF | OFF | ON | ON |
| Mag2 | OFF | ON | ON | ON | OFF | ON | ON | OFF | OFF | OFF | ON | OFF |
| Demag | OFF | OFF | OFF | OFF | ON | ON | OFF | OFF | OFF | OFF | ON | ON |

TABLE 2
Transistor Maximum Voltages - Mode M1

| Q1 | Q2 | Q3 | Q4 | Q5 | Q6 |
|---|---|---|---|---|---|
| $\frac{{V}_{in} - {V}_{out}}{3}$ | $2 * \frac{{V}_{in} - {V}_{out}}{3}$ | $\frac{{V}_{in} - {V}_{out}}{3}$ | $\frac{{V}_{in} - {V}_{out}}{3}$ | $\frac{{V}_{in} - {V}_{out}}{3}$ | $\frac{{V}_{in} - {V}_{out}}{3}$ |
| Q7 | Q8 | Q9 | Q10 | Q11 | Q12 |
| $\frac{{V}_{in} - {V}_{out}}{3}$ | $2 * \frac{{V}_{in} - {V}_{out}}{3}$ | $\frac{{V}_{in} - {V}_{out}}{3}$ | $\frac{{V}_{in} - {V}_{out}}{3}$ | $\frac{{V}_{in} - {V}_{out}}{3}$ | $\frac{{V}_{in} - {V}_{out}}{3}$ |

As a result of such a switching sequence (during one cycle) definition, hybrid DC-DC converter 100 performs a conversion voltage from Vᵢₙ to Vₒᵤₜ, in accordance with the equations:

$$d = \frac{3 C R}{1 - C R} for 0 < C R < \frac{1}{4} , \qquad ( 5 )$$

$$Δ IL = \frac{C R * ( 1 - 4 C R ) )}{3 * ( 1 - C R )} for 0 < CR < \frac{1}{4} , \qquad ( 6 )$$

where:

$$d = duty cycle = \frac{Ton}{T} ( defined based on FIG . 2 ) , and$$

$$CR = Conversion Ratio = \frac{V out}{V in} .$$

ΔI_{L}=Normalized (to Vᵢₙ*T/L) Inductor current ripple (as depicted in FIG. 2).

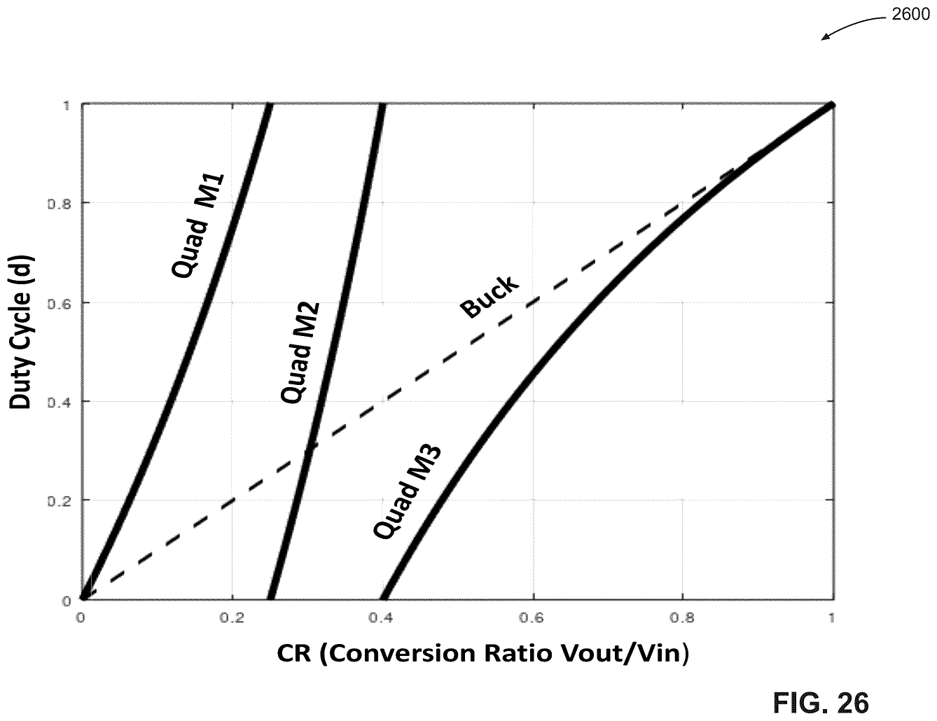

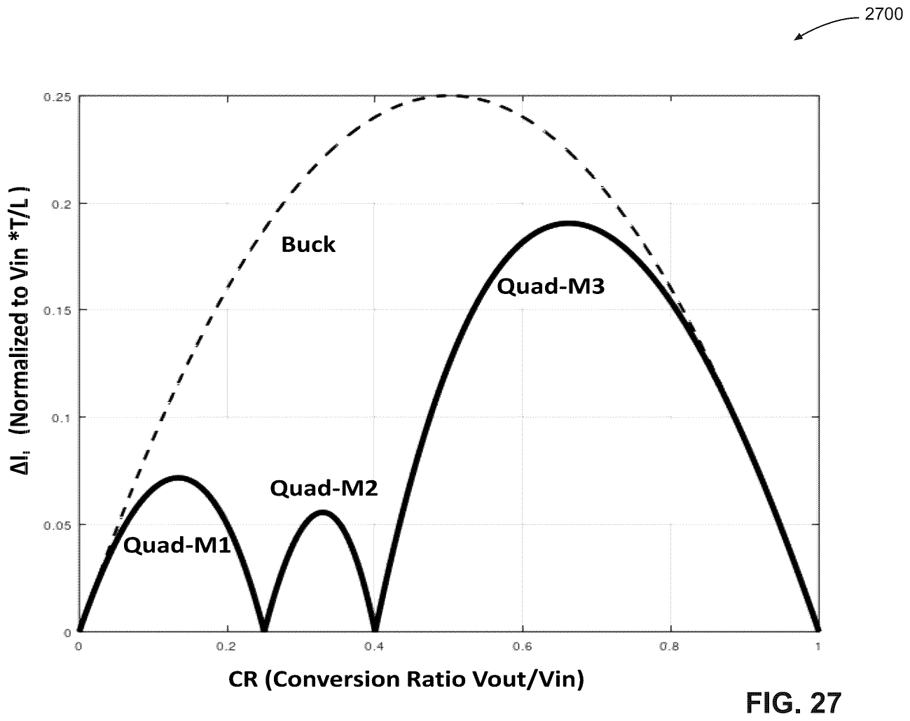

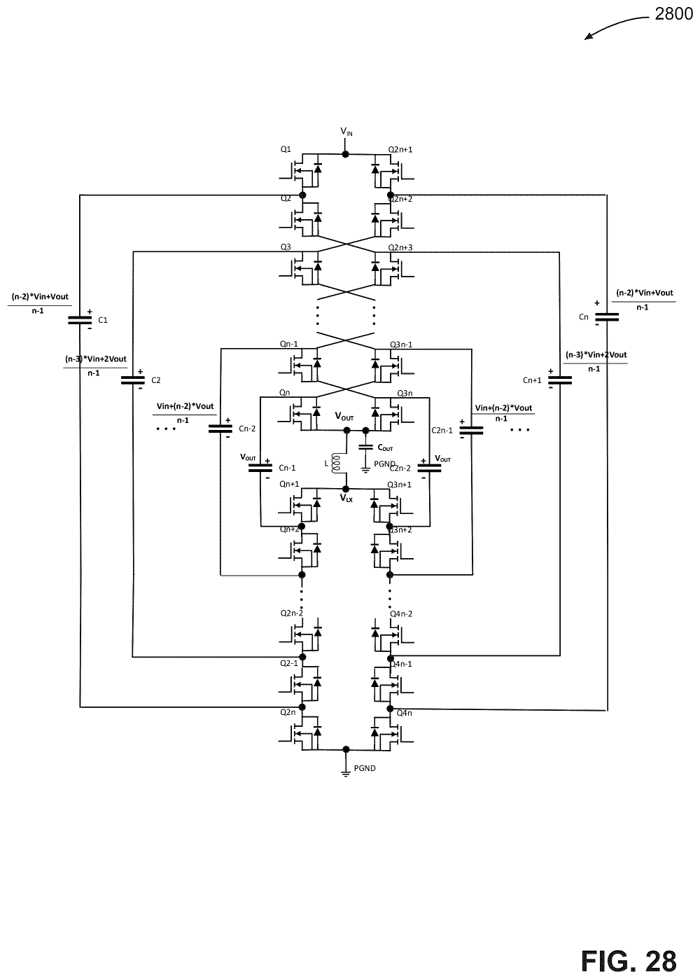

A plot of d versus time is shown in FIG. 26. A plot of ΔI_{L} versus time is shown in FIG. 27.

There are many advantages offered by such hybrid architecture as used in hybrid DC-DC converter 100:
Efficiency:

Because V_{LX}=(Vᵢₙ−Vₒᵤₜ)/3 during magnetization, the inductor has low current ripple and core losses are very low. In contrast, a buck converter has V_{LX}=Vᵢₙ−Vₒᵤₜ. As a result of this, it will have three times more ripple current and almost 10 times more core losses on the associated inductor than the hybrid converters described herein. A comparative plot is presented in FIG. 27.

Because of the use of multiple current paths, the inductor current is divided into three paths connected in parallel instead of a single path used in a traditional buck converter. Power loss on a resistive path is proportional to I². Based on the following inequality:

$${( {I}_{1} + {I}_{2} + {I}_{3} )}^{2} \geq {I}_{1}^{2} + {I}_{2}^{2} + {I}_{3}^{2} ,$$

Losses on a single resistive path collecting all currents are higher than losses on multiple resistive paths, each of them conducting a fraction of the overall current.

Direct current resistance (DCR) losses on the inductor are proportional to

$${I}_{L}^{2} .$$

Unlike a buck converter where I_{L}=I_{LOAD}, the hybrid DC-DC converter embodiments described herein, using a smart switching sequence, supply the current to the load via two paths: through inductor L, and directly to Vₒᵤₜ bypassing the inductor. Lowering the inductor current by 25%, at the same load current, hybrid DC-DC converter 100 reduces the DCR losses by 50% compared with a buck converter.
Use of low voltage FET for High voltage input rail.
Low voltage ripple on Vₒᵤₜ:

There is a reduced current ripple at the Vₒᵤₜ node compared with a charge pump because just a small portion of the load comes directly into the output node, bypassing the inductor. 75% of the current load comes to Vₒᵤₜ through the inductor which blocks any high current spikes.

### Scalability:

The schematic allows the hybrid DC-DC converter 100 circuit to be scaled to an arbitrary division coefficient, n. This might be necessary either when the input voltage is higher or when a lower voltage on the switching node (V_{LX}=(Vᵢₙ−Vₒᵤₜ)/n) is needed. Any adjustment of the schematic associated with the hybrid DC-DC converter 100 circuit can be done just by inserting more FETs both on top and on bottom sections of the schematic and adjusting the pre-bias voltages on the flying capacitors as described subsequently. The advantage of keeping the switching node at a relatively low voltage (Vᵢₙ−Vₒᵤₜ)/n can be preserved in modified circuit topologies with all advantages discussed herein.

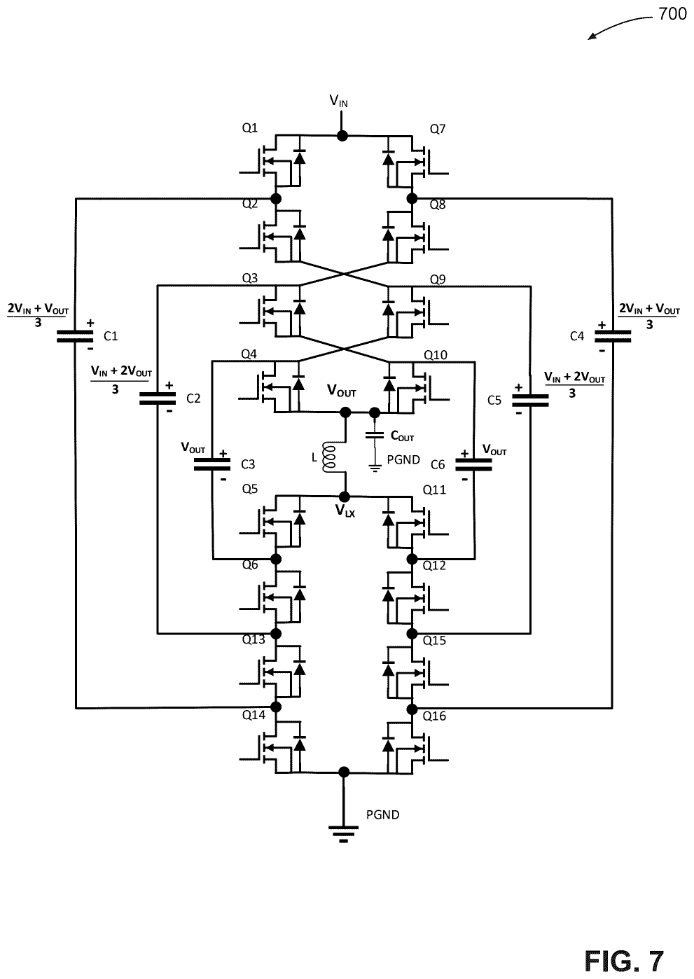

FIG. 7 is a circuit diagram of a hybrid DC-DC converter 700. Hybrid DC-DC converter 700 is a variant of hybrid DC-DC converter 100, obtained by adding four additional switching transistors—Q13, Q14, Q15, and Q16, to the second electrical network. The pre-bias voltages on flying capacitors C1-C6 in hybrid DC-DC converter 700 are identical to the respective pre-bias voltages on flying capacitors C1-C6 in hybrid DC-DC converter 100.

In hybrid DC-DC converter 700, the flying capacitors C1-C6 are connected differently from the flying capacitors C1-C6 in hybrid DC-DC converter 100. Specifically, in hybrid DC-DC converter 700:
C1 connects a transistor terminal connection node between switching transistors Q1 and Q2 to a transistor terminal connection node between switching transistors Q13 and Q14,
C2 connects a transistor terminal connection node between switching transistors Q3 and Q8 to a transistor terminal connection node between switching transistors Q6 and Q13,
C3 connects a transistor terminal connection node between switching transistors Q4 and Q9 to a transistor terminal connection node between switching transistors Q5 and Q6,
C4 connects a transistor terminal connection node between switching transistors Q7 and Q8 to a transistor terminal connection node between switching transistors Q15 and Q16,
C5 connects a transistor terminal connection node between switching transistors Q2 and Q9 to a transistor terminal connection node between switching transistors Q12 and Q15, and
C6 connects a transistor terminal connection node between switching transistors Q3 and Q10 to a transistor terminal connection node between switching transistors Q11 and Q12.

In an aspect, hybrid DC-DC converter 700 is configured to support a Mode 2 (M2) of operation, defined by the equation:

$$5 / 2 * {V}_{out} < {V}_{in} < 4 * {V}_{out} .$$

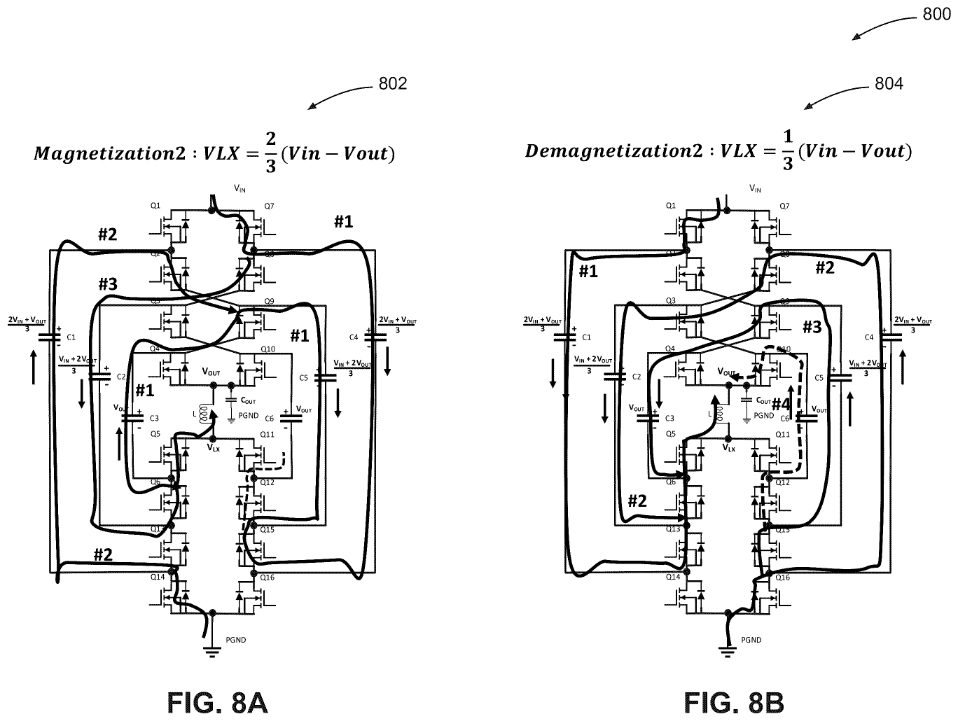

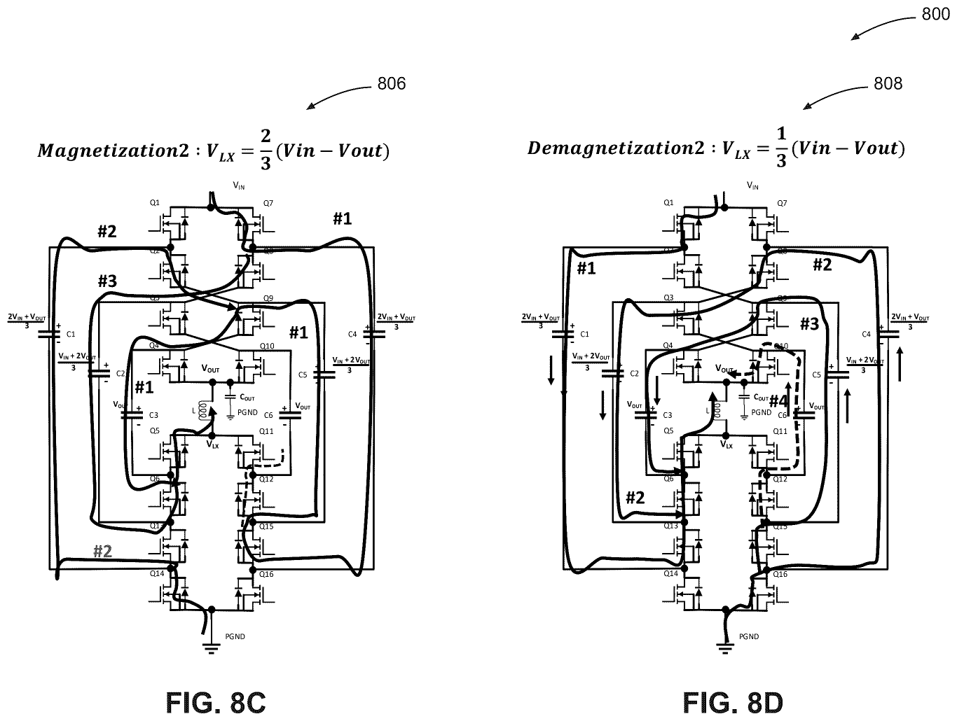

The functionality of hybrid DC-DC converter 700 operating in Mode 2 (M2) is similar to that of hybrid DC-DC converter 100 operating in Mode 1 (M1); however, the switching sequence within one cycle is different. In the case of hybrid DC-DC converter 700, there are now two distinct demagnetization states—Demagnetization 1 (Demag1), and Demagnetization 2 (Demag2). Hence, a single cycle of a switching system state associated with hybrid DC-DC converter 700 follows the four-state sequence Magnetization1, Demagnetization1, Magnetization2, Demagnetization2. FIGS. 8A through 8D are circuit diagrams depicting hybrid DC-DC converter 700 in the different switching system states.

FIG. 8A is a circuit diagram of hybrid DC-DC converter 700 depicting a magnetization state 802. Magnetization state 802 is a switching system state that may be associated with magnetization state Mag1 for mode M2. The corresponding equation for this state is:

$${V}_{LX} = \frac{2}{3} ( {V}_{in} - {V}_{out} ) > {V}_{out} . \qquad ( 7 )$$

The different current paths are:
Path #1 current (through inductor): Vᵢₙ, Q1, C1, Q13, C2, Q3, C6, Q11, inductor, out
Path #2 current (through inductor): PGND, Q16, C4, Q8, Q3, C6, Q11, inductor, Vₒᵤₜ
Path #3 current (through inductor): Vᵢₙ, Q1, Q2, C5, Q12, Q11, inductor, Vₒᵤₜ

FIG. 8B is a circuit diagram of hybrid DC-DC converter 700 depicting a demagnetization state 804. Demagnetization state 804 is a switching system state that may be associated with demagnetization state Demag1 for mode M2. The corresponding equation for this state is:

$${V}_{LX} = \frac{1}{3} ( {V}_{in} - {V}_{out} ) < {V}_{out} . \qquad ( 8 )$$

The different current paths are:
Path #1 current (through inductor): Vᵢₙ, Q7, C4, Q15, Q12, Q11, inductor, Vₒᵤₜ
Path #2 current (through inductor): PGND, Q14, C1, Q2, C5, Q12, Q11, inductor, Vₒᵤₜ
Path #3 current (through inductor): PGND, Q14, Q13, C2, Q3, C5, Q11, inductor, Vₒᵤₜ
Path #4 current (direct to Vₒᵤₜ): PGND, Q14, Q13, Q6, C3, Q4, Vₒᵤₜ

FIG. 8C is a circuit diagram of hybrid DC-DC converter 700 depicting a magnetization state 806. Magnetization state 806 is a switching system state that may be associated with magnetization state Mag2 for mode M2. The corresponding equation for this state is:

$${V}_{LX} = \frac{2}{3} ( {V}_{in} - {V}_{out} ) > {V}_{out} . \qquad ( 9 )$$

The different current paths are:
Path #1 current (through inductor): Vᵢₙ, Q7, C4, Q15, C5, Q9, C3, Q5, inductor, Vₒᵤₜ
Path #2 current (through inductor): PGND, Q14, C1, Q2, Q9, C3, Q5, inductor, Vₒᵤₜ
Path #3 current (through inductor): Vᵢₙ, Q7, Q8, C2, Q6, Q5, inductor, Vₒᵤₜ

FIG. 8D is a circuit diagram of hybrid DC-DC converter 700 depicting a demagnetization state 808. Demagnetization state 808 is a switching system state that may be associated with demagnetization state Demag2 for mode M2. The corresponding equation for this state is:

$${V}_{LX} = \frac{1}{3} ( {V}_{in} - {V}_{out} ) < {V}_{out} . \qquad ( 10 )$$

The different current paths are:
Path #1 current (through inductor): Vᵢₙ, Q1, C1, Q13, Q6, Q5, inductor, Vₒᵤₜ
Path #2 current (through inductor): PGND, Q16, C4, Q8, C2, Q6, Q5, inductor, Vₒᵤₜ
Path #3 current (through inductor): PGND, Q16, Q15, C5, Q9, C3, Q5, inductor, Vₒᵤₜ
Path #4 current (direct to Vₒᵤₜ): PGND, Q16, Q15, Q12, C6, Q10, Vₒᵤₜ

Table 3 provides a summary of mode M2 functionality over 1 cycle (Mag1|Demag1|Mag2|Demag2|) for hybrid DC-DC converter 700:

TABLE 3
Transistor Switching States - Mode M2

| | Q1 | Q2 | Q3 | Q4 | Q5 | Q6 | Q7 | Q8 | Q9 | Q10 | Q11 | Q12 |
|---|---|---|---|---|---|---|---|---|---|---|---|---|
| Mag1 | ON | ON | ON | OFF | OFF | ON | OFF | ON | OFF | OFF | ON | ON |
| Demag | OFF | ON | ON | ON | OFF | ON | ON | OFF | OFF | OFF | ON | ON |
| Mag2 | OFF | ON | OFF | OFF | ON | ON | ON | ON | ON | OFF | OFF | ON |
| Demag | ON | OFF | OFF | OFF | ON | ON | OFF | ON | ON | ON | OFF | ON |

| | Q13 | Q14 | Q15 | Q16 |
|---|---|---|---|---|
| Mag1 | ON | OFF | OFF | ON |
| Demag | ON | ON | ON | OFF |
| Mag2 | OFF | ON | ON | OFF |
| Demag | ON | OFF | ON | ON |

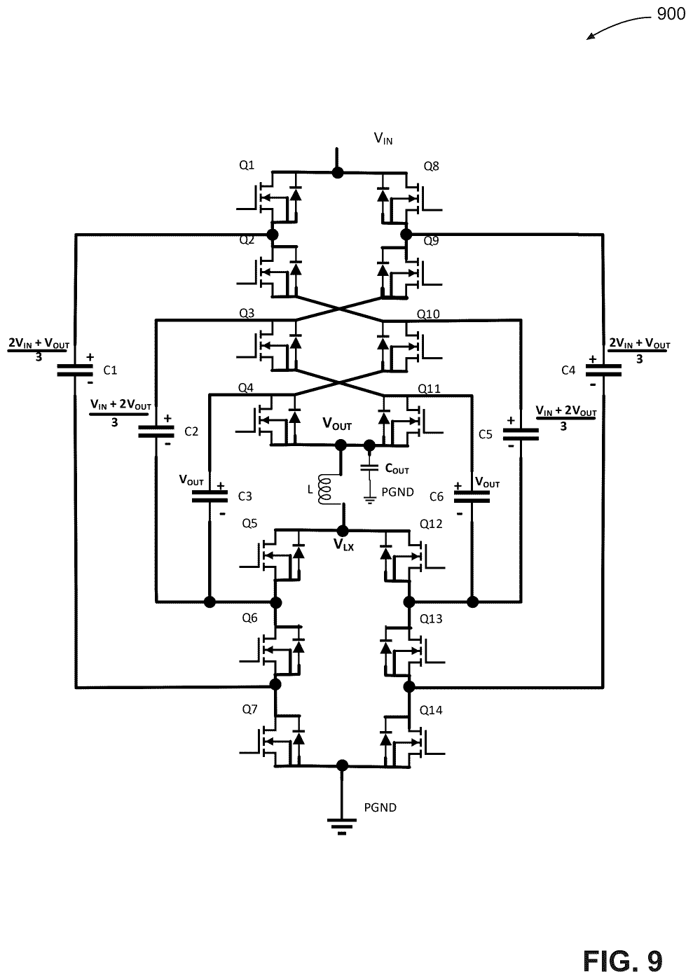

FIG. 9 is a circuit diagram of a hybrid DC-DC converter 900. In one aspect, in hybrid DC-DC converter 700, switching transistors Q6 and Q12 are always in an ON state. Hence, these switching transistors in hybrid DC-DC converter 700 can be replaced by wires to obtain a circuit topology for hybrid DC-DC converter 900 with identical functionality as hybrid DC-DC converter 700.

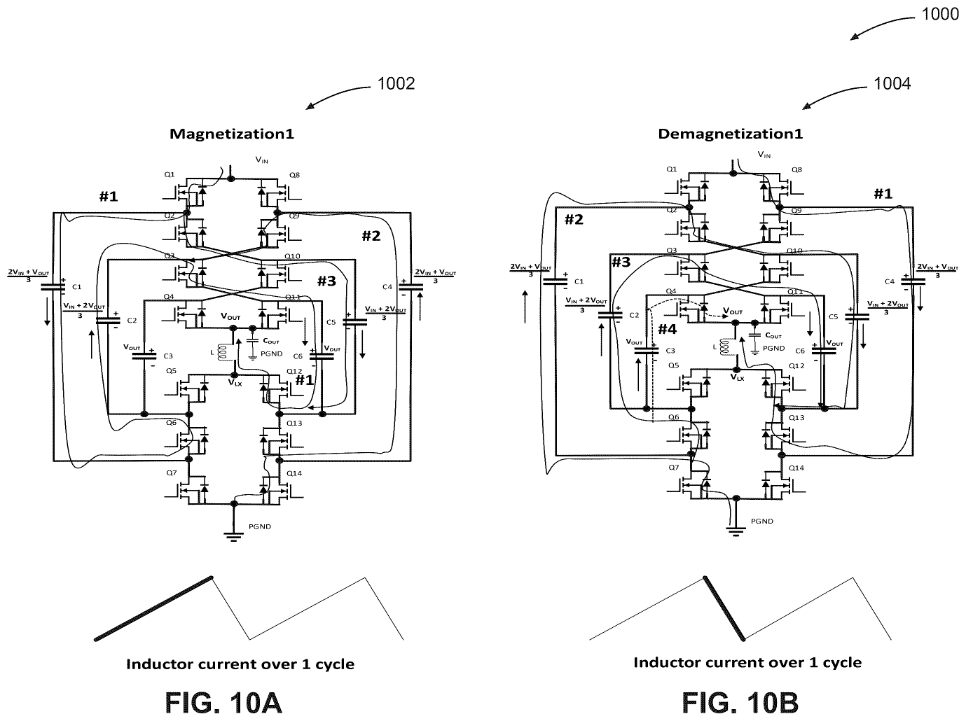

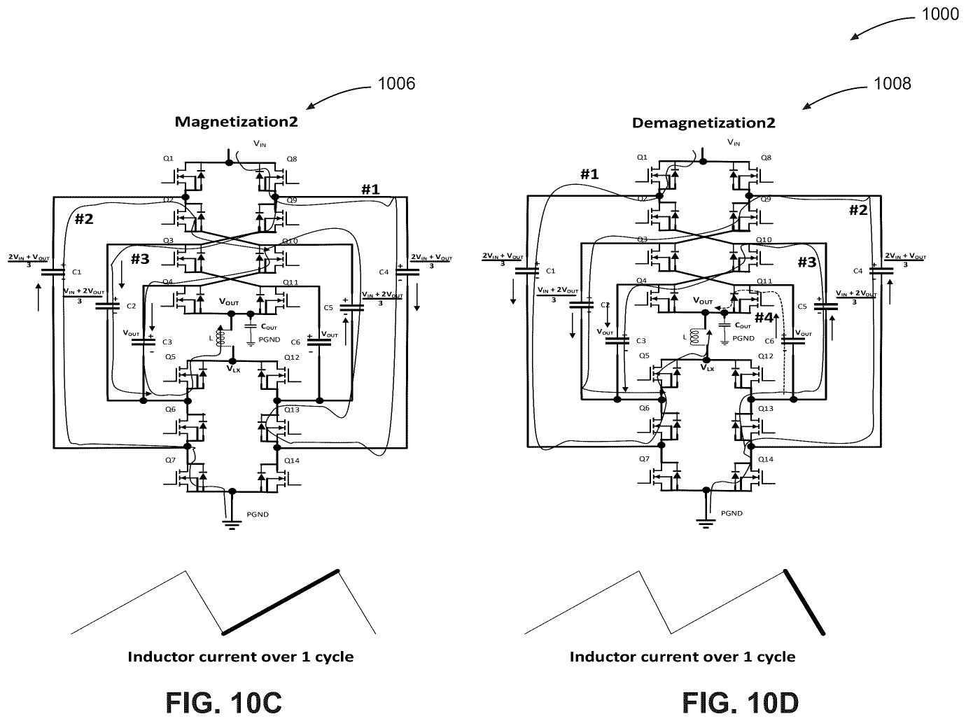

FIGS. 10A through 10D are circuit diagrams depicting a hybrid DC-DC converter 900 in different switching system states associated with a single switching system state cycle. FIG. 10A depicts a Mag1 state 1002, FIG. 10B depicts a Demag1 state 1004, FIG. 10C depicts a Mag1 state 1006, and FIG. 10D depicts a Demag2 state 1008 associated with an operation of hybrid DC-DC converter 900. Since hybrid DC-DC converter 900 is functionally identical to hybrid DC-DC converter 700, states 1002, 1004, 1006 and 1008 are functionally identical to states 802, 804, 806 and 808, respectively.

FIG. 10A is a circuit diagram of hybrid DC-DC converter 900 depicting a magnetization state 1002. Magnetization state 1002 is a switching system state that may be associated with magnetization state Mag1 for mode M2. The corresponding equation for this state is:

$${V}_{LX} = \frac{2}{3} ( {V}_{in} - {V}_{out} ) > {V}_{out} . \qquad ( 7 )$$

The different current paths are:
Path #1 current (through inductor): Vᵢₙ, Q1, C1, Q6, C2, Q3, C6, Q12, inductor, Vₒᵤₜ
Path #2 current (through inductor): PGND, Q14, C4, Q9, Q3, C6, Q12, inductor, Vₒᵤₜ
Path #3 current (through inductor): Vᵢₙ, Q1, Q2, C5, Q12, inductor, Vₒᵤₜ

FIG. 10B is a circuit diagram of hybrid DC-DC converter 900 depicting a demagnetization state 1004. Demagnetization state 1004 is a switching system state that may be associated with demagnetization state Demag1 for mode M2. The corresponding equation for this state is:

$${V}_{LX} = \frac{1}{3} ( {V}_{in} - {V}_{out} ) < {V}_{out} . \qquad ( 8 )$$

The different current paths are:
Path #1 current (through inductor): Vᵢₙ, Q8, C4, Q13, Q12, inductor, Vₒᵤₜ
Path #2 current (through inductor): PGND, Q7, C1, Q2, C5, Q12, inductor, Vₒᵤₜ
Path #3 current (through inductor): PGND, Q7, Q6, C2, Q3, C5, Q12, inductor, Vₒᵤₜ
Path #4 current (direct to Vₒᵤₜ): PGND, Q7, Q6, C3, Q4, Vₒᵤₜ

FIG. 10C is a circuit diagram of hybrid DC-DC converter 900 depicting a magnetization state 1006. Magnetization state 1006 is a switching system state that may be associated with magnetization state Mag2 for mode M2. The corresponding equation for this state is:

$${V}_{LX} = \frac{2}{3} ( {V}_{in} - {V}_{out} ) > {V}_{out} . \qquad ( 9 )$$

The different current paths are:
Path #1 current (through inductor): Vᵢₙ, Q8, C4, Q13, C5, Q10, C3, Q5, inductor, Vₒᵤₜ
Path #2 current (through inductor): PGND, Q7, C1, Q2, Q10, C3, Q5, inductor, Vₒᵤₜ
Path #3 current (through inductor): Vᵢₙ, Q8, Q9, C2, Q5, inductor, Vₒᵤₜ

FIG. 10D is a circuit diagram of hybrid DC-DC converter 900 depicting a demagnetization state 1008. Demagnetization state 1008 is a switching system state that may be associated with demagnetization state Demag2 for mode M2. The corresponding equation for this state is:

$${V}_{LX} = \frac{1}{3} ( {V}_{in} - {V}_{out} ) < {V}_{out} . \qquad ( 10 )$$

The different current paths are:
Path #1 current (through inductor): Vᵢₙ, Q1, C1, Q6, Q5, inductor, Vₒᵤₜ
Path #2 current (through inductor): PGND, Q14, C4, Q9, C2, Q5, inductor, Vₒᵤₜ
Path #3 current (through inductor): PGND, Q14, Q13, C5, Q10, C3, Q5, inductor, Vₒᵤₜ
Path #4 current (direct to Vₒᵤₜ): PGND, Q14, Q13, C6, Q11, Vₒᵤₜ

Tables 4 and 5 provide a summary of mode M2 functionality over 1 cycle (Mag1|Demag1|Mag2|Demag2|) for hybrid DC-DC converter 900:

TABLE 4
Transistor Switching States - Mode M2

| | Q1 | Q2 | Q3 | Q4 | Q5 | Q6 | Q7 | Q8 | Q9 | Q10 | Q11 | Q12 | Q13 | Q14 |
|---|---|---|---|---|---|---|---|---|---|---|---|---|---|---|
| Mag1 | ON | ON | ON | OFF | OFF | ON | OFF | OFF | ON | OFF | OFF | ON | OFF | ON |
| Demag | OFF | ON | ON | ON | OFF | ON | ON | ON | OFF | OFF | OFF | ON | ON | OFF |
| Mag2 | OFF | ON | OFF | OFF | ON | OFF | ON | ON | ON | ON | OFF | OFF | ON | OFF |
| Demag | ON | OFF | OFF | OFF | ON | ON | OFF | OFF | ON | ON | ON | OFF | ON | ON |

TABLE 5
Transistor Maximum Voltages - Mode M2

| Q1 | Q2 | Q3 | Q4 | Q5 | Q6 |
|---|---|---|---|---|---|
| $\frac{{V}_{in} - {V}_{out}}{3}$ | $2 * \frac{{V}_{in} - {V}_{out}}{3}$ | $2 * \frac{{V}_{in} - {V}_{out}}{3}$ | $\frac{{V}_{in} - {V}_{out}}{3}$ | $\frac{{V}_{in} - {V}_{out}}{3}$ | $2 * \frac{{V}_{in} - {V}_{out}}{3}$ |
| Q7 | Q8 | Q9 | Q10 | Q11 | Q12 |
| $\frac{{V}_{in} - {V}_{out}}{3}$ | $\frac{{V}_{in} - {V}_{out}}{3}$ | $2 * \frac{{V}_{in} - {V}_{out}}{3}$ | $2 * \frac{{V}_{in} - {V}_{out}}{3}$ | $\frac{{V}_{in} - {V}_{out}}{3}$ | $\frac{{V}_{in} - {V}_{out}}{3}$ |
| Q13 | Q14 | | | | |
| $2 * \frac{{V}_{i n} - {V}_{o u t}}{3}$ | $\frac{{V}_{i n} - {V}_{o u t}}{3}$ | | | | |

As a result of such a switching sequence (during one cycle) definition, the hybrid DC-DC converter 700 performs a conversion voltage from Vᵢₙ to Vₒᵤₜ, in accordance with the equations:

$$\begin{matrix}d = \frac{4 CR - 1}{1 - CR} & for \frac{1}{4} < CR < \frac{2}{5}\end{matrix} \qquad ( 11 )$$

$$\begin{matrix}Δ {I}_{L} = \frac{( 2 - 5 CR ) * ( 4 CR - 1 )}{3 * ( 1 - CR )} & for \frac{1}{4} < CR < \frac{2}{5}\end{matrix} \qquad ( 12 )$$

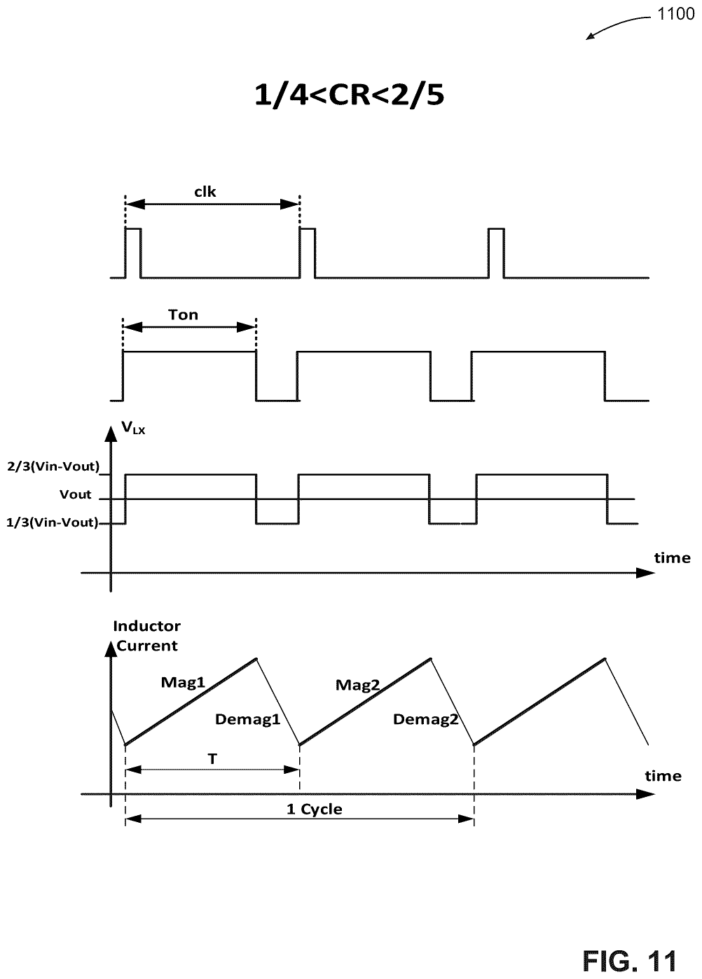

FIG. 11 is a timing diagram 1100 depicting a plurality of electrical signals associated with an operation of hybrid DC-DC converters 700 and 900. Timing diagram 1100 is similar to timing diagram 200, only that timing diagram 1100 is related to mode M2, while timing diagram 200 is related to mode M1. In timing diagram 200, characteristic to M1, the V_{LX} (switching) node is seen to switch between

$$\frac{1}{3} ( {V}_{in} - {V}_{out} )$$

and 0, with Vₒᵤₜ in between. In timing diagram 1100, characteristic to mode M2, the V_{LX} node switches between

$$\frac{2}{3} ( {V}_{in} - {V}_{out} ) and \frac{1}{3} ( {V}_{in} - {V}_{out} )$$

keeping the Vₒᵤₜ (output) node in between.

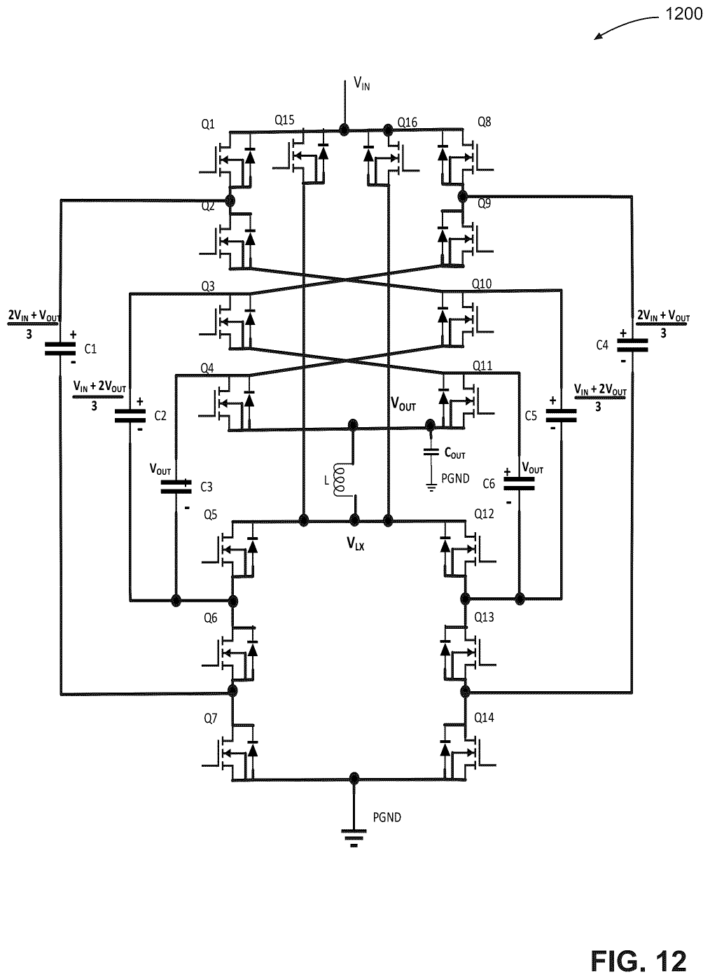

FIG. 12 is a circuit diagram of a hybrid DC-DC converter 1200 is configured to support a Mode 3 (M3) of operation, defined by the equation:

$${V}_{out} < {V}_{in} < 5 / 2 * {V}_{out} .$$

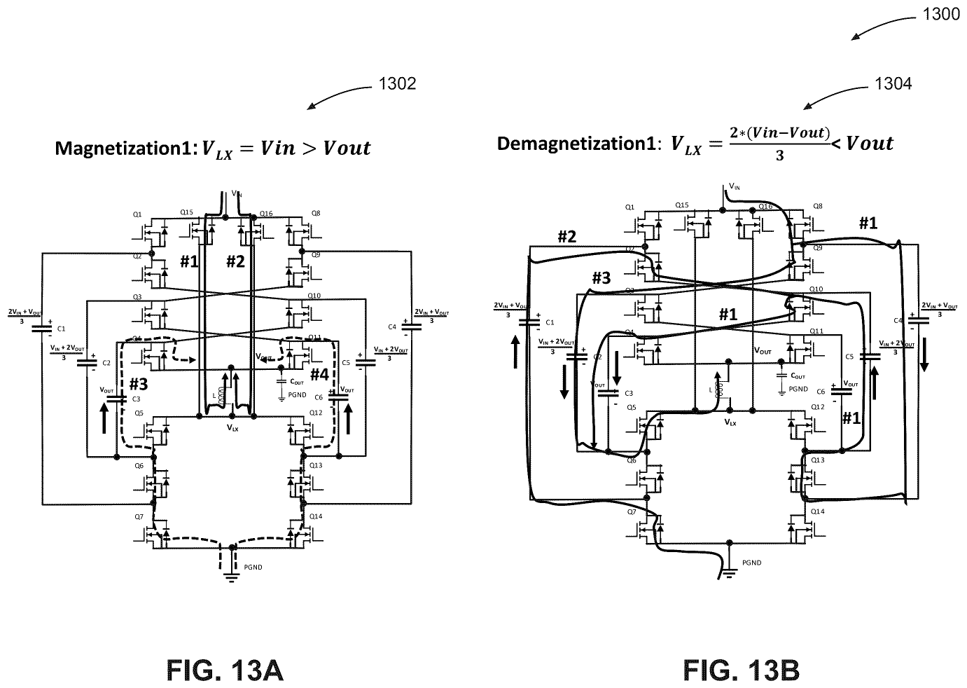

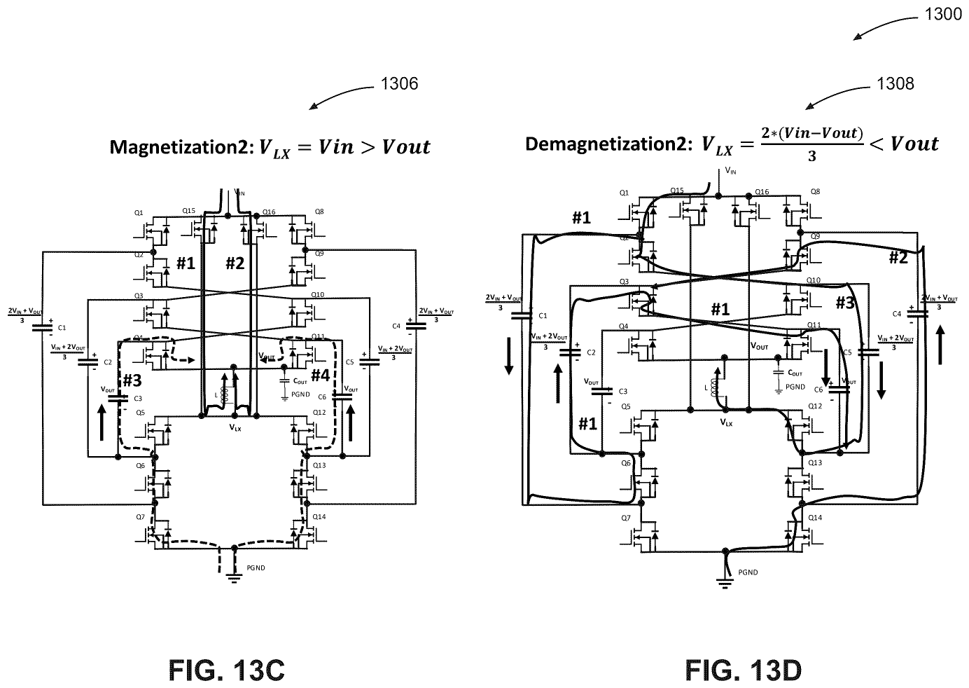

The functionality of hybrid DC-DC converter 1200 operating in Mode 3 (M3) is similar to that of hybrid DC-DC converter 100 operating in Mode 1 (M1); however, the switching sequence within one cycle is different. In the case of hybrid DC-DC converter 1200, there are now two distinct demagnetization states-Demagnetization 1 (Demag1), and Demagnetization 2 (Demag2). Hence, a single cycle of a switching system state associated with hybrid DC-DC converter 1200 follows the four-state sequence Magnetization1, Demagnetization1, Magnetization2, Demagnetization2. FIGS. 13A through 13D are circuit diagrams depicting hybrid DC-DC converter 1200 in the different switching system states.

FIGS. 13A through 13D are circuit diagrams depicting hybrid DC-DC converter 1200 in different switching system states.

FIG. 13A is a circuit diagram of hybrid DC-DC converter 1200 depicting a magnetization state 1302. Magnetization state 1302 is a switching system state that may be associated with magnetization state Mag1 for mode M3. The different current paths are:
Path #1 current (through inductor): Vᵢₙ, Q15, inductor, Vₒᵤₜ
Path #2 current (through inductor): Vᵢₙ, Q16, inductor, Vₒᵤₜ
Path #3 current (direct to Vₒᵤₜ): PGND, Q6, Q7, C3, Q4, Vₒᵤₜ
Path #4 current (direct to Vₒᵤₜ): PGND, Q13, Q14, C6, Q11, Vₒᵤₜ

FIG. 13B is a circuit diagram of hybrid DC-DC converter 1200 depicting a demagnetization state 1304. Demagnetization state 1304 is a switching system state that may be associated with demagnetization state Demag1 for mode M3. The different current paths are:
Path #1 current (through inductor): Vᵢₙ, Q8, C4, Q13, C5, Q10, C3, Q5, inductor, Vₒᵤₜ
Path #2 current (through inductor): PGND, Q7, C1, Q2, Q10, C3, Q5, inductor, Vₒᵤₜ
Path #3 current (through inductor): Vᵢₙ, Q8, Q9, C2, Q5, inductor, Vₒᵤₜ

FIG. 13C is a circuit diagram of hybrid DC-DC converter 1200 depicting a magnetization state 1306. Magnetization state 1306 is a switching system state that may be associated with magnetization state Mag2 for mode M3. The different current paths are:
Path #1 current (through inductor): Vᵢₙ, Q15, inductor, Vₒᵤₜ
Path #2 current (through inductor): Vᵢₙ, Q16, inductor, Vₒᵤₜ
Path #3 current (direct to Vₒᵤₜ): PGND, Q6, Q7, C3, Q4, Vₒᵤₜ
Path #4 current (direct to Vₒᵤₜ): PGND, Q13, Q14, C6, Q11, Vₒᵤₜ

FIG. 13D is a circuit diagram of hybrid DC-DC converter 1200 depicting a demagnetization state 1308. Demagnetization state 1308 is a switching system state that may be associated with demagnetization state Demag2 for mode M3. The different current paths are:
Path #1 current (through inductor): Vᵢₙ, Q1, C1, Q6, C2, Q3, C6, Q12, inductor, Vₒᵤₜ
Path #2 current (through inductor): PGND, Q14, C4, Q9, Q3, C6, Q12, inductor, Vₒᵤₜ
Path #3 current (through inductor): Vᵢₙ, Q1, Q2, C5, Q12, inductor, Vₒᵤₜ

The corresponding equations relating to the M3 mode of operation are:

$$\begin{matrix}d = \frac{5 CR - 2}{1 + 2 CR} & for \frac{2}{5} < CR < 1\end{matrix} \qquad ( 13 )$$

$$\begin{matrix}Δ {I}_{L} = \frac{( 1 - CR ) * ( 5 CR - 2 )}{1 + 2 CR} & for \frac{2}{5} < CR < 1\end{matrix} \qquad ( 14 )$$

Tables 6 and 7 provide a summary of mode M3 functionality over 1 cycle (Mag1|Demag1|Mag2|Demag2|) for hybrid DC-DC converter 1200:

TABLE 6
Transistor Switching States - Mode M3

| | Q1 | Q2 | Q3 | Q4 | Q5 | Q6 | Q7 | Q8 |
|---|---|---|---|---|---|---|---|---|
| Mag1 | OFF | OFF | OFF | ON | OFF | ON | ON | OFF |
| Demag | OFF | ON | OFF | OF | ON | OFF | ON | ON |
| Mag2 | OFF | OFF | OFF | ON | OFF | ON | ON | OFF |
| Demag | ON | ON | ON | OFF | OFF | ON | OFF | OFF |
| | Q9 | Q10 | Q11 | Q12 | Q13 | Q14 | Q15 | Q16 |
| Mag1 | OFF | OFF | ON | OFF | ON | ON | ON | ON |
| Demag | ON | ON | OFF | OFF | ON | OFF | OFF | OFF |
| Mag2 | OFF | OFF | ON | OFF | ON | ON | ON | ON |
| Demag | ON | OFF | OFF | ON | OFF | ON | OFF | OFF |

TABLE 7
Transistor Maximum Voltages - Mode M3

| Q1 | Q2 | Q3 | Q4 | Q5 | Q6 |
|---|---|---|---|---|---|
| $\frac{{V}_{i n} - {V}_{o u t}}{3}$ | $\frac{{V}_{i n} - {V}_{o u t}}{3}$ | $2 * \frac{{V}_{i n} - {V}_{o u t}}{3}$ | $2 * \frac{{V}_{i n} - {V}_{o u t}}{3}$ | Vᵢₙ | $2 * \frac{{V}_{i n} - {V}_{o u t}}{3}$ |
| Q7 | Q8 | Q9 | Q10 | Q11 | Q12 |
| $\frac{{V}_{i n} - {V}_{o u t}}{3}$ | $\frac{{V}_{i n} - {V}_{o u t}}{3}$ | $\frac{{V}_{i n} - {V}_{o u t}}{3}$ | $2 * \frac{{V}_{i n} - {V}_{o u t}}{3}$ | $2 * \frac{{V}_{i n} - {V}_{o u t}}{3}$ | Vᵢₙ |
| Q13 | Q14 | Q15 | Q16 | | |
| $2 * \frac{{V}_{i n} - {V}_{o u t}}{3}$ | $\frac{{V}_{i n} - {V}_{o u t}}{3}$ | $\frac{{V}_{i n} + 2 {V}_{out}}{3}$ | $\frac{{V}_{in} + 2 {V}_{out}}{3}$ | | |

The transistor maximum voltage values presented in tables 2, 5 and 7 are drain-source voltages on the respective FETs in an OFF state. These values can be determined by checking current path voltages during the corresponding switching sequences. These values are important for selection of the ‘n’ level of the associated hybrid DC-DC converter. For example, suppose Vᵢₙ=100V and Vₒᵤₜ=1V. A Quad configuration with Vᵢₙ>4Vₒᵤₜ can be chosen to include 4 stacked FETs in the first electrical network. But to conform with tables 2, 5 and 7, the FETs need to be of 50V capacities. If the number of stacked devices is increased from 4 to, for example 8, the voltage capacity requirement on the FETs will drop to 10V.

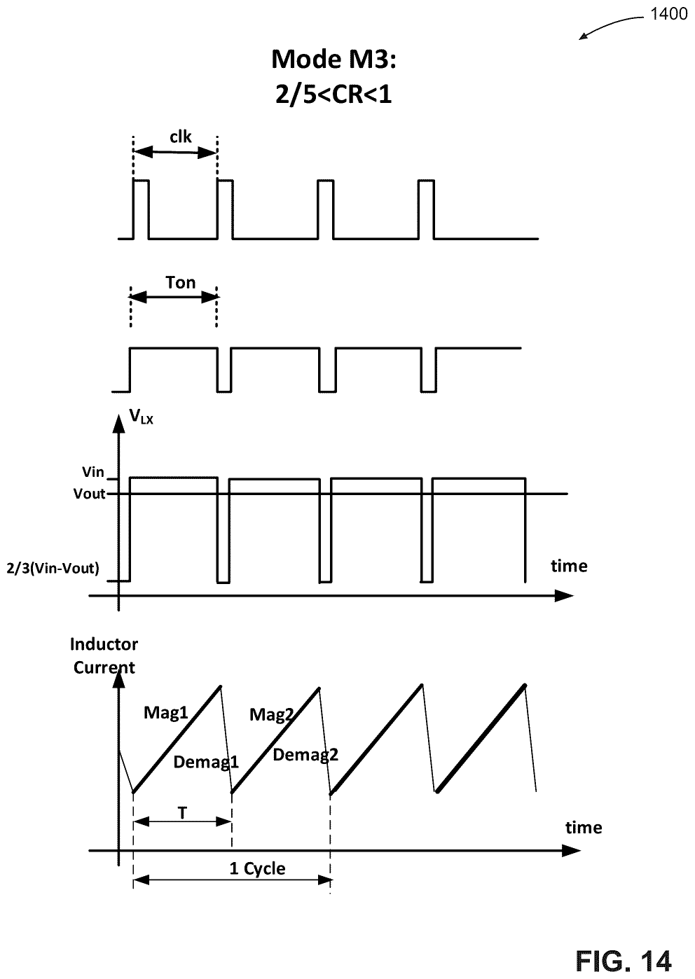

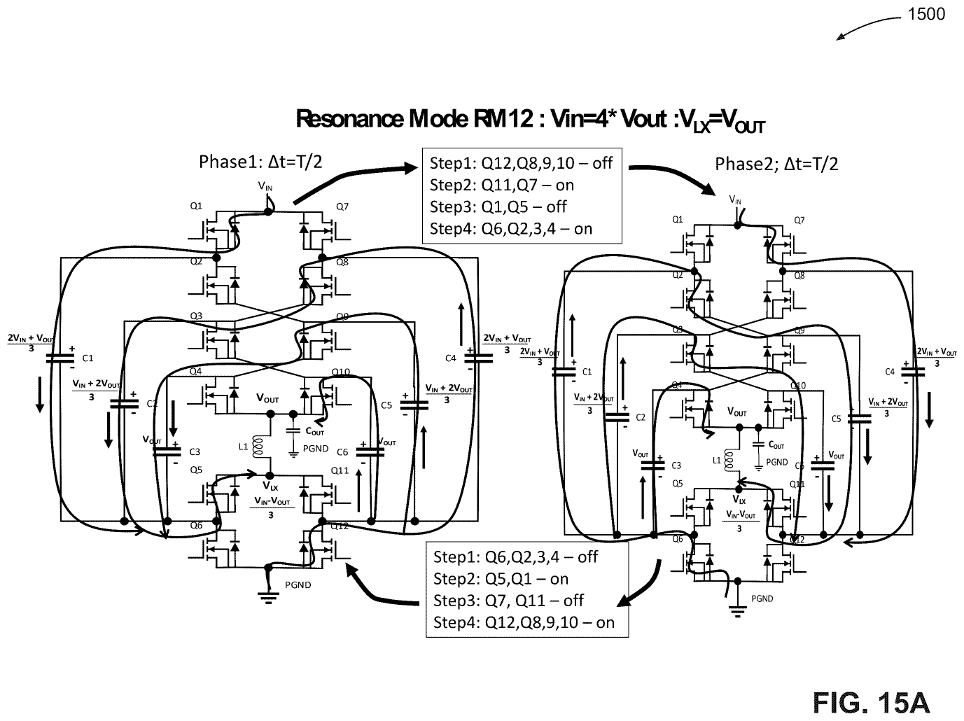

FIG. 14 is a timing diagram depicting a plurality of electrical signals associated with an operation of hybrid DC-DC converter 1200 in mode M3. Timing diagram 1400 is similar to timing diagram 200, only that timing diagram 1400 is related to mode M3, while timing diagram 200 is related to mode M1. In this mode M3 of operation, the switching node V_{LX} switches between Vᵢₙ and

$$\frac{2}{3} ( {V}_{in} - {V}_{out} )$$

Some embodiments of hybrid DC-DC converters can be configured to implement one or more resonant modes of operation. For example, a Resonant Mode RM12 and a Resonant Mode RM23 can be implemented. RM12 happens at the transition of Mode1 to Mode2, and vice versa. RM23 happens at the transition of M2 to M3, and vice versa. Unlike the modes of operations discussed above, RM12 and RM23 work with fixed CR (but different from each other). Because a conversion from Vᵢₙ to Vₒᵤₜ is fixed, the proposed schematic works as a voltage divider with a division factor equal with Vᵢₙ/Vₒᵤₜ=1/CR. Both resonant modes are necessary to cover the functionality of the hybrid DC-DC converter for a full voltage range of Vᵢₙ.

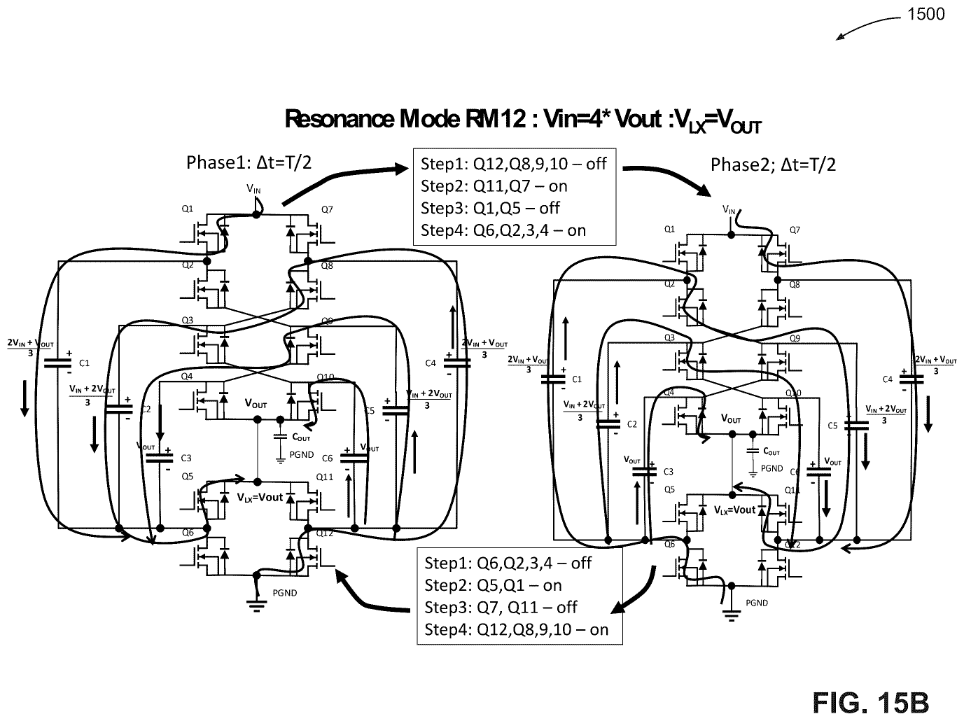

FIGS. 15A and 15B depict different embodiments of a DC-DC hybrid converter configured to implement a resonant mode of operation. In one aspect, hybrid DC-DC converter 100 is configured to implement resonant mode RM12, as depicted in FIGS. 15A and 15B. The RM12 mode is associated with the relationship Vᵢₙ=4*Vₒᵤₜ (voltage divider with a factor of 4).

From Eq. (5) above it can be seen that for Vᵢₙ=4*Vₒᵤₜ, the duty cycle d=1. This means that there is only magnetization of the inductor. This is impossible to hold this condition of magnetization, because it makes inductor current increase indefinitely. So, the switching sequence from mode M1 cannot apply in this condition.

To implement the RM12 mode using hybrid DC-DC converter 100, a different switching sequence is proposed, where each cycle has 2 switching system states/phases:
Phase1 (for half of the period) where the current paths from FIG. 3 are maintained (i.e., Mag1 state 300).
Phase 2 (for half of the period) where the current paths from FIG. 5 are maintained (i.e., Mag2 state 500).

In both phases, the voltages on flying capacitors maintain the same voltages as in all previous modes. As a result,

$${V}_{LX} = \frac{1}{3} * ( Vin - {V}_{out} ) = \frac{1}{3} * ( 4 {V}_{out} - {V}_{out} ) = {V}_{out}$$

$$Δ {V}_{L} = {V}_{LX} - {V}_{out} = 0$$

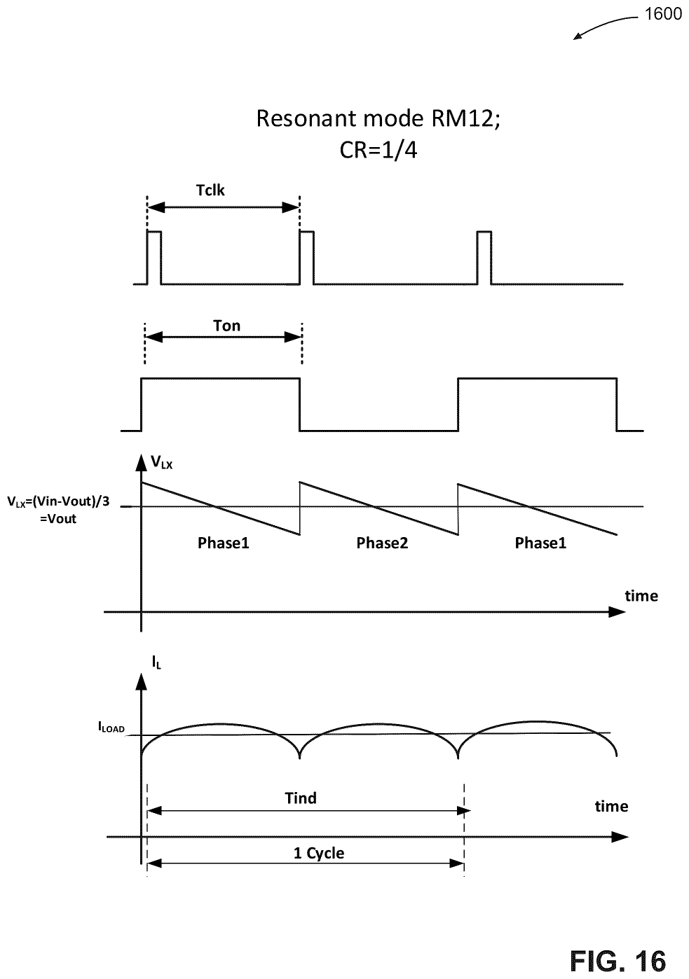

However, this value is just an average voltage value on the inductor. During Phase 1, C1, C2, C3 are charging and C4, C5, C6 are discharging. As a result, V_{LX} is not exactly equal to Vₒᵤₜ, but slightly higher and lower than Vₒᵤₜ. In one aspect, the inductor current has the shape of a rectified sinusoidal waveform with a small amplitude, that oscillates around the current load value. That is why this mode of operation, is referred to as a “resonant mode” RM12. Current and voltage waveforms associated with resonant mode RM12 are presented in FIG. 16.

It can be seen that as the V_{LX} node starts dropping from a maximum value higher than Vₒᵤₜ, the inductor is magnetized with a positive slope of the current waveform. When the V_{LX} node reaches Vₒᵤₜ, the voltage on the inductor will be 0, and the slope of the current waveform will be 0. The inductor current waveform is flattened and further, it starts dropping due to a negative slope (V_{LX} is less than Vₒᵤₜ). The dropping continues until the clk signal arrives and a new cycle starts.

FIG. 15A depicts transitions 1500 from Phase 1 to Phase 2 and back in the RM12 mode for hybrid DC-DC converter 100. The transition from Phase 1 to Phase 2 follows a strict protocol which avoids strong demagnetization of the inductor. There are 4 switching time steps for this transition:
Step 1: Q12 off, followed by Q8, Q9, Q10 off.
Step 2: Q11 on followed by Q7 on.
Step 3: Q1 off followed by Q5 off.
Step 4: Q6 on, followed by Q2, Q3 on.

The transition from Phase 2 to Phase 1 follows a sequence of complementary time steps:
Step1: Q6 off, followed by Q2, Q3, Q4 off.
Step2: Q5 on followed by Q1 on.
Step3: Q7 off followed by Q11 off.
Step4: Q12 on, followed by Q8, Q9, Q10 on.

An advantage of the RM12 mode of operation is a very low ripple of the inductor current which makes the core loss of the inductor almost 0.

A variant of the topology of hybrid DC-DC converter 100 operating in the RM12 mode is depicted in FIG. 15B. FIG. 15B shows the transitions 1500 for a circuit topology that is a variation of the circuit topology associated with hybrid DC-DC converter 100. The circuit topology depicted in FIG. 15B is the same as that of hybrid DC-DC converter 100, only that the circuit topology depicted in FIG. 15B does not include the inductor L. This is possible because V_{LX}=Vₒᵤₜ and the inductor can be replaced by a wire as shown in FIG. 15B. Eliminating the inductor increases efficiency by reducing the losses associated with DCR of the inductor and the magnetic core the inductor.

FIG. 16 is a timing diagram 1600 depicting a plurality of electrical signals associated with an operation of hybrid DC-DC converter 100 (and the variant depicted in FIG. 15B) in resonant mode RM12. FIG. 16 shows the two distinct phases of operation, as well as the low inductor ripple current.

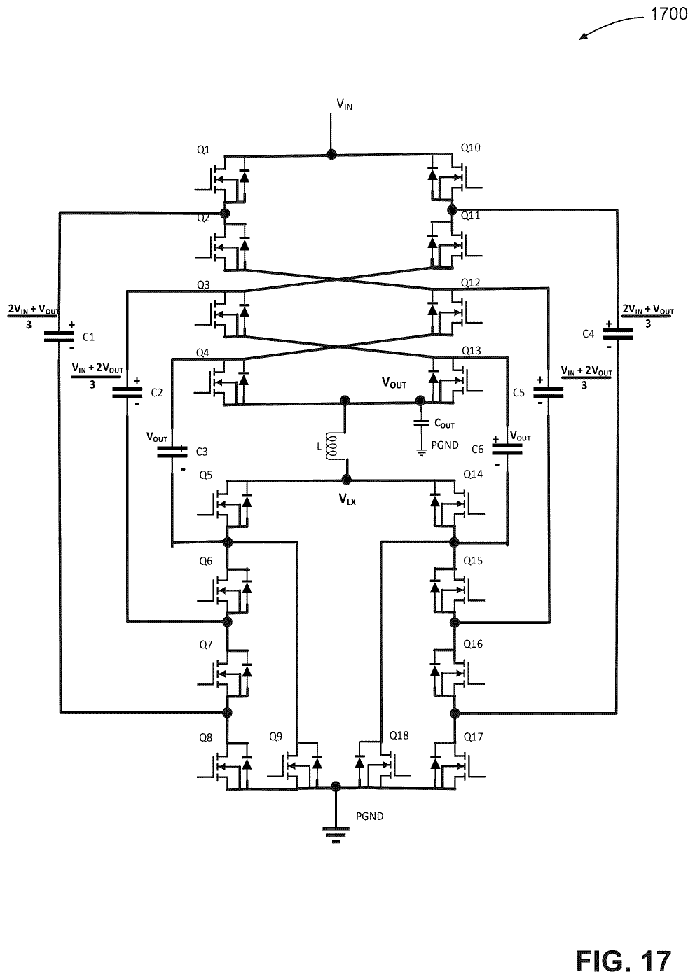

FIG. 17 is a circuit diagram of a hybrid DC-DC converter 1700. In an aspect, hybrid DC-DC converter 1700 supports a resonant mode RM23 of operation, governed by the equation:

$${V}_{in} = 5 / 2 * {V}_{out} ( voltage divider with factor 2.5 ) .$$

Hybrid DC-DC converter 1700 is also able to support modes M1, RM12 and M2, in addition to RM23.

Equation (11) shows that for Vᵢₙ=5/2*Vₒᵤₜ, the associated duty cycle d=1. This means that there is only magnetization of the inductor. This condition is impossible to hold because it makes inductor current increase indefinitely. So, the switching sequence of mode M2 cannot apply anymore in this condition.

Hybrid DC-DC converter 1700 supports the resonant mode RM23, while implementing a different switching sequence as compared to the switching sequence associated with mode M2. The circuit topology associated with hybrid DC-DC converter 1700 shows two more switches (i.e., switching transistors) connected to GND, based on the circuit topology of hybrid DC-DC converter 700. In essence, the circuit topology for hybrid DC-DC converter 1700 is obtained by adding two additional switching transistors in the second electrical network of hybrid DC-DC converter 700.

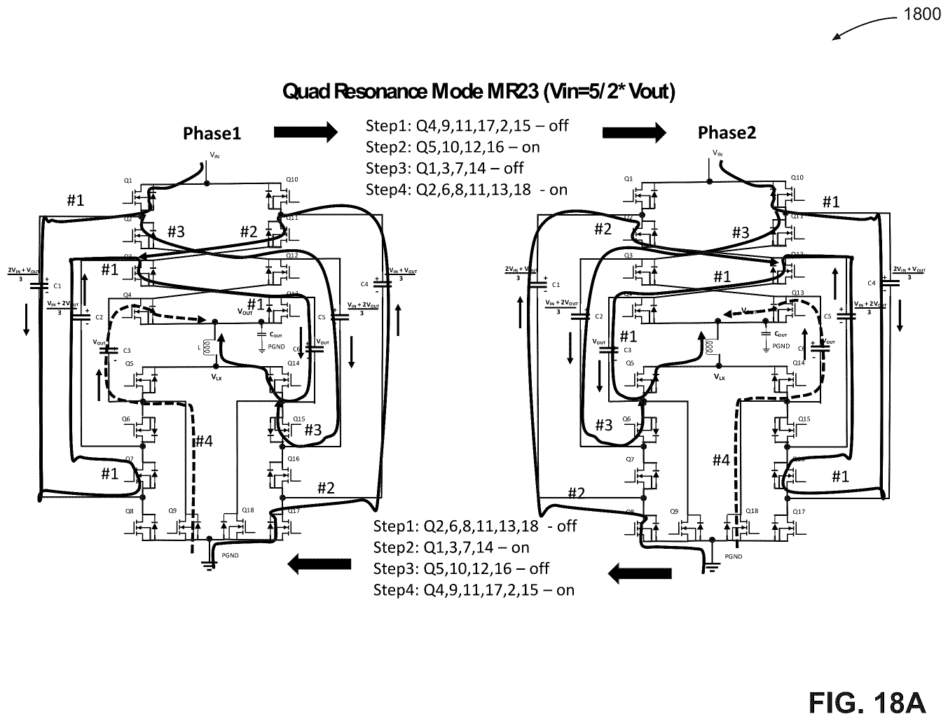

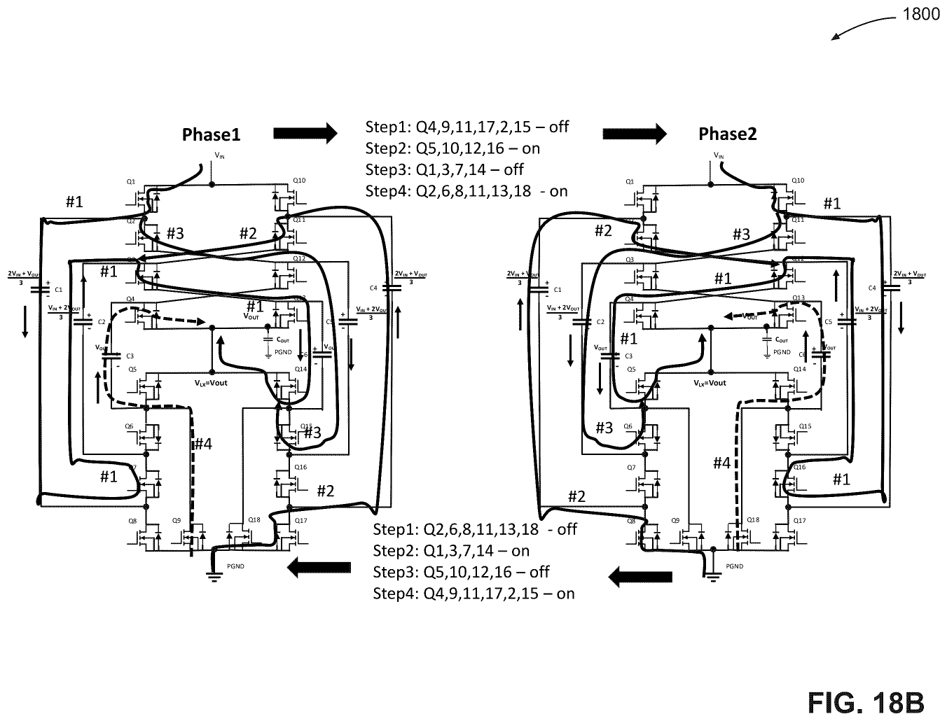

FIGS. 18A and 18B depict different embodiments of a DC-DC hybrid converter configured to implement resonant mode RM23.

FIG. 18A depicts transitions 1800 from Phase 1 to Phase 2 and back in the RM23 mode for hybrid DC-DC converter 1700. FIG. 18A shows current paths, 2 phases per cycle and a sequence of 4 time-steps for transitions between phases.

As a result,

$${V}_{LX} = \frac{2}{3} * ( {V}_{in} - {V}_{out} ) = \frac{2}{3} * ( \frac{5}{2} * {V}_{out} - {V}_{out} ) = {V}_{out}$$

$$Δ {V}_{L} = {V}_{LX} - {V}_{out} = 0$$

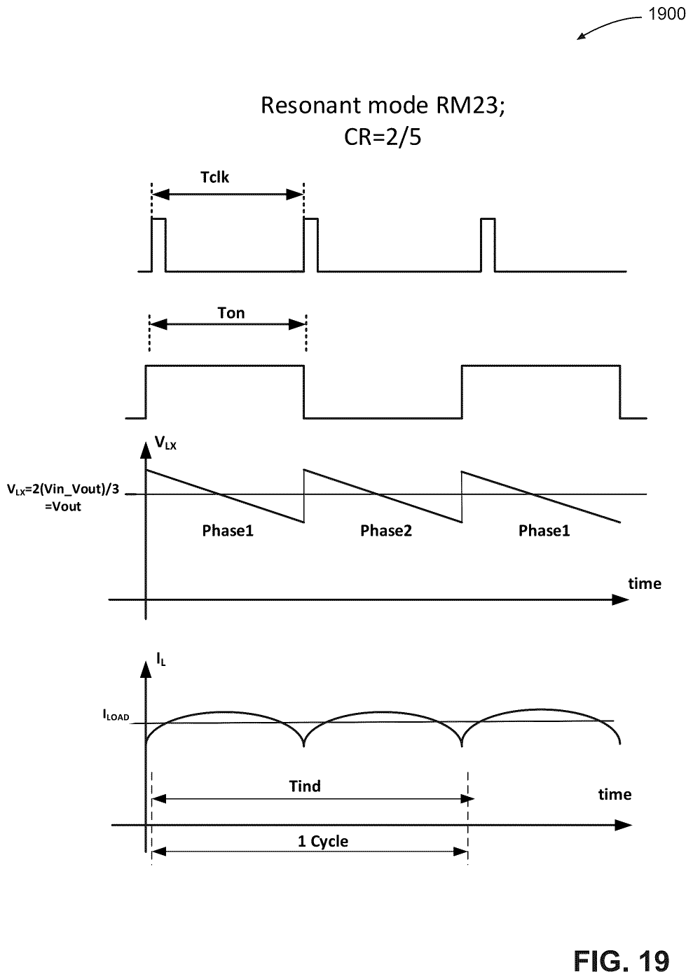

However, this value is just an average voltage value on the inductor. During Phase1, C1, C5, C6 are charging and C2, C3, C4 are discharging. As a result, V_{LX} is not exactly equal to Vₒᵤₜ, but slightly higher and lower than Vₒᵤₜ, as shown in the timing diagram in FIG. 19. In an aspect, the inductor current has the shape of a sinusoidal waveform with a small amplitude. The inductor current oscillates around the current load value. That is why this mode of operation is referred to as “resonant mode RM23”. Current and voltage waveforms associated with resonant mode RM23 are presented in FIG. 17.

Transition from Phase1 to Phase2 in transitions 1800 follows a strict protocol which avoids strong demagnetization of the inductor. There are 4 switching time steps for this transition:
Step1: Q2, Q4, Q9, Q11, Q15, Q17→off
Step2: Q5, Q10, Q12, Q16→on.
Step3: Q1, Q3, Q7, Q14→off
Step4: Q2, Q6, Q8, Q11, Q13, Q18→on.

Transition from Phase 2 to Phase 1 follows a sequence of complementary time steps:
Step1: Q2, Q6, Q8, Q11, Q13, Q18→on.
Step2: Q1, Q3, Q7, Q14→off
Step3: Q5, Q10, Q12, Q16→on.
Step4: Q2, Q4, Q9, Q11, Q15, Q17→off

A variant of the topology of hybrid DC-DC converter operating in the RM23 mode is depicted in FIG. 18B. FIG. 18B shows the transitions 1800 for a circuit topology that is a variation of the circuit topology associated with hybrid DC-DC converter 1700. The circuit topology depicted in FIG. 18B is the same as that of hybrid DC-DC converter 1700, only that the circuit topology depicted in FIG. 18B does not include the inductor L. This is possible because V_{LX}=Vₒᵤₜ and the inductor can be replaced by a wire as shown in FIG. 18B. Eliminating the inductor increases efficiency by reducing the losses associated with DCR of the inductor and the magnetic core the inductor. However, without the inductor, this topology can be used only as a voltage divider. Any change of Vᵢₙ will produce a change in Vₒᵤₜ. For regulation of Vₒᵤₜ, the inductor is needed.

Adding two additional switching transistors (e.g., FETs) to the circuit topology of hybrid DC-DC converter 700 improves performance during implementation of the M2 mode, both during magnetization and demagnetization switching system states. During magnetization (FIG. 8A), capacitor C3 is in an idle state (of neither charge nor discharge), making the functionality somewhat asymmetrical. In FIG. 18A and FIG. 18B, all flying capacitors are either charged or discharged. During demagnetization (FIG. 8B) there is a long resistive path of inductor current (Q15, Q12, Q11). In FIG. 18A, the additional FETs shorten this path. The circuit topologies presented in FIGS. 18A and 18B thus provide better performance as compared to hybrid DC-DC converter 700.

FIG. 19 is a timing diagram 1900 depicting a plurality of electrical signals associated with an operation of hybrid DC-DC converter 1700 (and the variant depicted in FIG. 18B) in resonant mode RM23. FIG. 19 shows the two distinct phases of operation, as well as the low inductor ripple current.

FIGS. 16 and 19 show an advantage of the resonant modes of operation (RM12 and RM23). Operating in these modes produces an extremely low ripple of the inductor current. The core losses of the inductor are almost zero, and the efficiency of the converter increases.

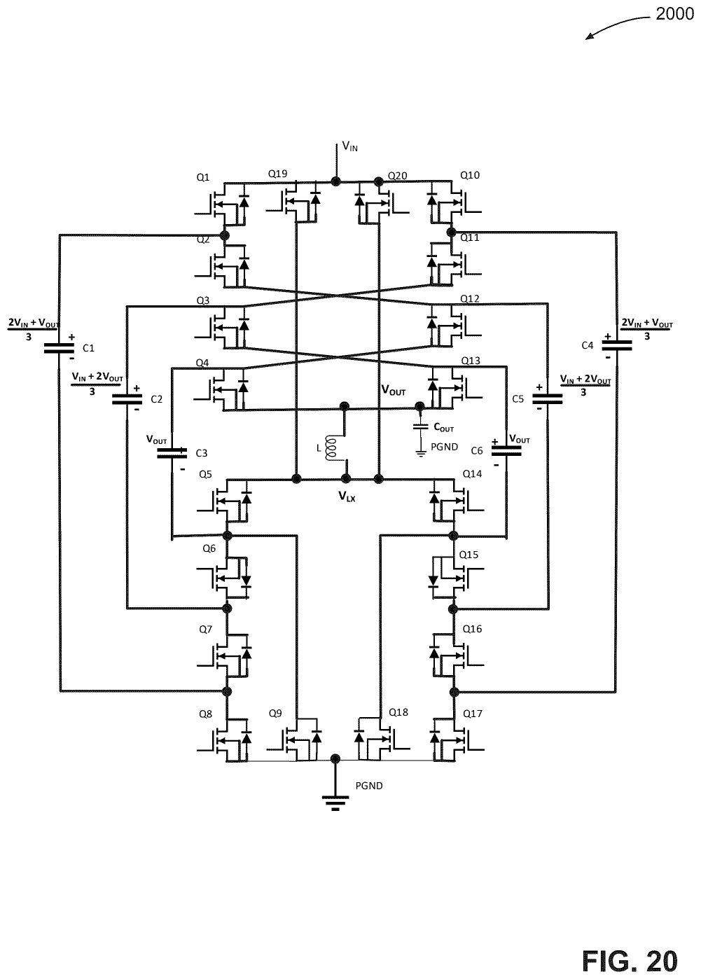

FIG. 20 is a circuit diagram of a generalized hybrid DC-DC converter 2000. The circuit topologies described thus far (e.g., hybrid DC-DC converters 100, 700, and 1700) are different, and depend on the voltage range of Vᵢₙ. Most of the applications have a different but limited range of Vᵢₙ. In all these cases, the use of a dedicated schematic/circuit topology is advantageous because this approach reduces complexity and silicon area usage.

In some cases, Vᵢₙ may have a full range of variation (from Vₒᵤₜ up to more than 4Vₒᵤₜ). In this case, it is desirable to have a circuit that can perform the voltage conversion from Vᵢₙ to Vₒᵤₜ for the entire input voltage range. This means that a single circuit, with different switching sequences, can be configured to implement all 5 modes of operations. Hybrid DC-DC converter 2000 represents such a generalized circuit topology. In an aspect, hybrid DC-DC converter can be converted into any of the circuit topologies described earlier by maintaining each of a selected set of switching transistors in a permanently on or off state, depending on the voltage intervals associated with Vᵢₙ.

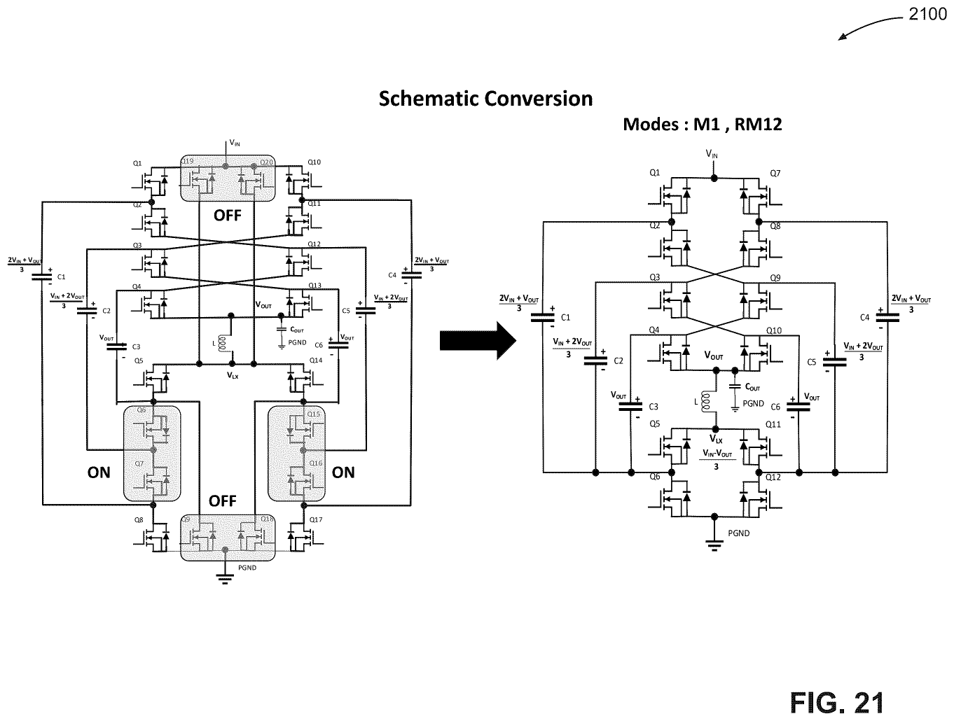

FIG. 21 is a schematic conversion diagram 2100 depicting an equivalence between two embodiments of a hybrid DC-DC converter. Conversion diagram 2100 depicts the conversion from the topology of hybrid DC-DC converter 2000 to the topology associated with hybrid DC-DC converter 100, which supports Mode M1 and Resonant Mode RM12 (Vᵢₙ≥4*Vₒᵤₜ). To achieve this conversion, switching transistors Q9, Q18, Q19, Q20 in hybrid DC-DC converter 2000 are always OFF and switching transistors Q6, Q7, Q15, Q16 in hybrid DC-DC converter 2000 are always ON. A disadvantage of using the generalized circuit topology of hybrid CD-CD converter 2000 is the added complexity, silicon area usage, and power consumption. Using a dedicated circuit topology for hybrid DC-DC converter 100 eliminates 8 switching transistors out of the 20 switching transistors of hybrid DC-DC converter 2000. This further results in a 40% saving of the silicon area and of the complexity of the associated schematic.

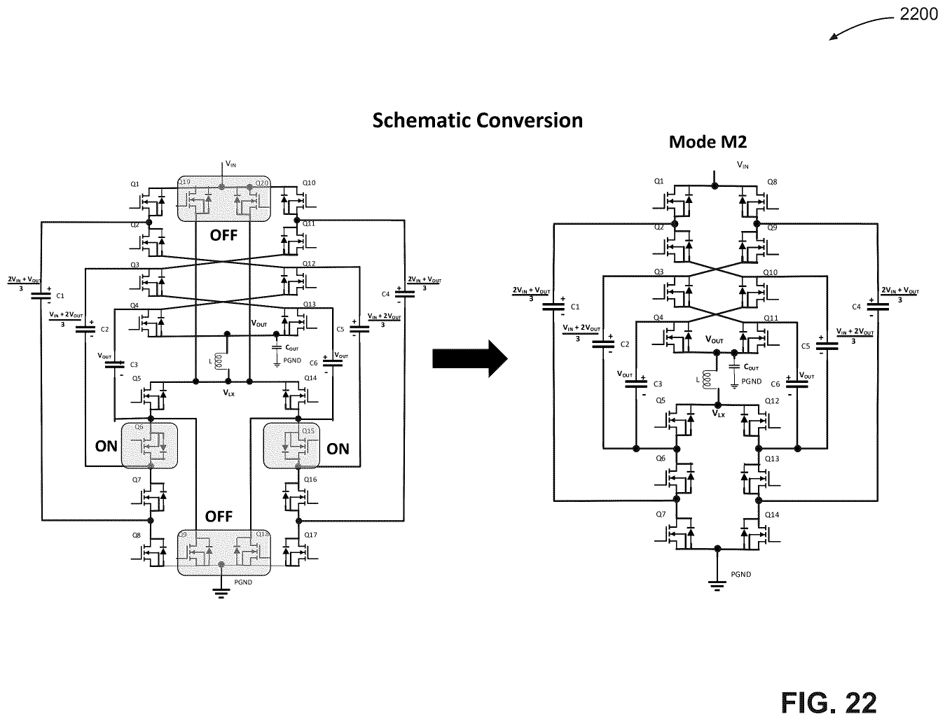

FIG. 22 is a schematic conversion diagram 2200 depicting an equivalence between two embodiments of a hybrid DC-DC converter. Conversion diagram 2200 depicts the conversion from the topology of hybrid DC-DC converter 2000 to the topology associated with hybrid DC-DC converter 900, which supports Mode M2. To achieve this conversion, switching transistors Q6, Q15 in hybrid DC-DC converter 2000 are always ON and switching transistors Q9, Q18, Q19, Q20 in hybrid DC-DC converter 2000 are always OFF. If the circuit topology of hybrid DC-DC converter 900 is used, there is a 30% saving of silicon area versus if the circuit topology of the hybrid DC-DC converter 2000 is used. Hybrid DC-DC converter 900 is also able to implement individual modes M1 and RM12 other than mode M2.

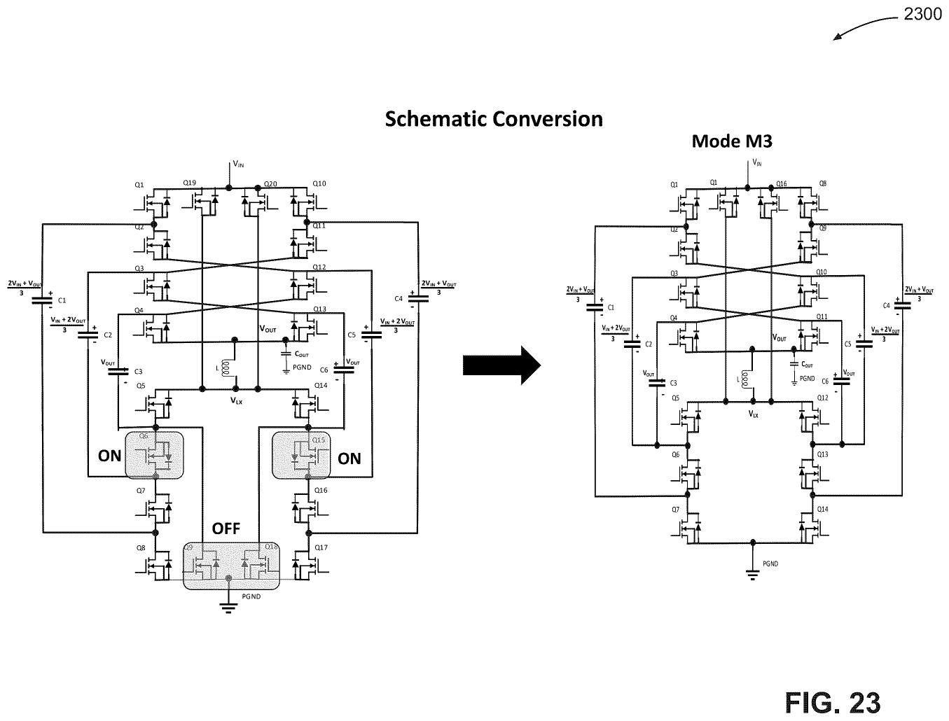

FIG. 23 is a schematic conversion diagram 2300 depicting an equivalence between two embodiments of a hybrid DC-DC converter. Conversion diagram 2300 depicts the conversion from the topology of hybrid DC-DC converter 2000 to the topology associated with hybrid DC-DC converter 1200, which supports Mode M3. To achieve this conversion, switching transistors Q16, Q15 in hybrid DC-DC converter 2000 are always ON and switching transistors Q9, Q18 in hybrid DC-DC converter 2000 are always OFF. If the circuit topology of hybrid DC-DC converter 1200 is used, there is a 20% saving of silicon area versus if the circuit topology of the hybrid DC-DC converter 2000 is used. Hybrid DC-DC converter 1200 is also able to implement individual modes M1, M2, and RM12 other than mode M3.

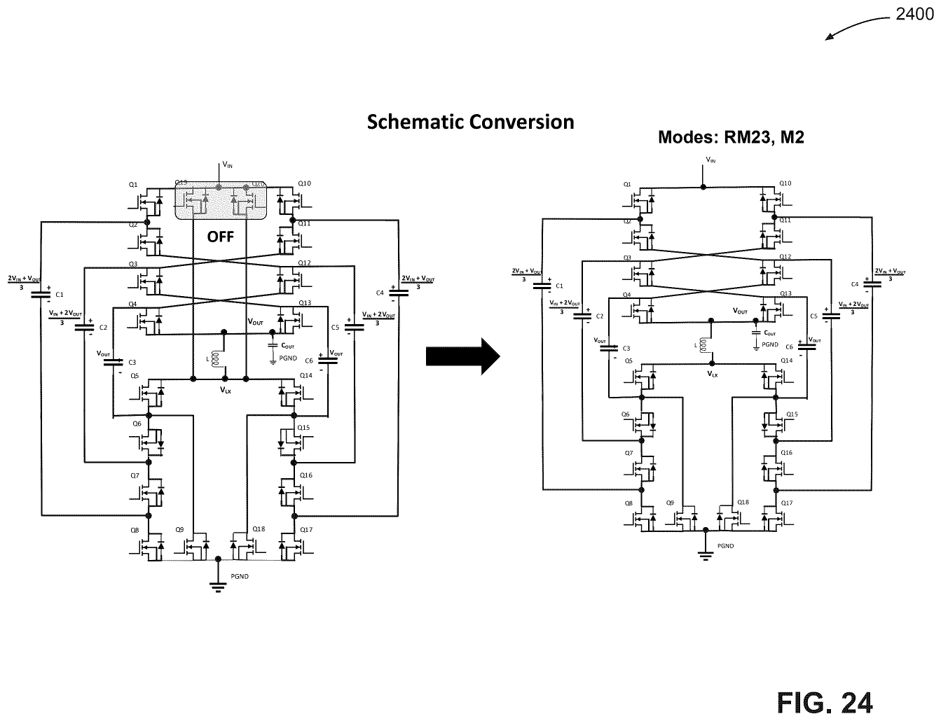

FIG. 24 is a schematic conversion diagram 2400 depicting an equivalence between two embodiments of a hybrid DC-DC converter. Conversion diagram 2400 depicts the conversion from the topology of hybrid DC-DC converter 2000 to the topology associated with hybrid DC-DC converter 1700, which supports Resonant Mode RM23. To achieve this conversion, switching transistors Q19, Q20 in hybrid DC-DC converter 2000 are always OFF. Hybrid DC-DC converter 1700 is also able to implement individual modes M1, M2, and RM12 other than mode RM23.

Table 8 presents associated equations for the hybrid DC-DC converters described herein, for all modes of operation. For comparison, the equations for a buck converter are included as well.

TABLE 8
DC-DC Converter Equations

| | | | Inductor current ripple (ΔI_{L}), |
|---|---|---|---|
| | Conversion Ratio | Duty Cycle | normalized to |
| Mode of Operation | $CR = \frac{{V}_{out}}{{V}_{in}}$ | $d = \frac{{T}_{mag}}{{T}_{inductor}}$ | ${V}_{in} * \frac{T}{L}$ |
| Quad - M1 | $0 < CR < \frac{1}{4}$ | $d = \frac{3 CR}{1 - CR}$ | $Δ {I}_{L} = \frac{CR * ( 1 - 4 CR )}{1 - CR}$ |
| Quad - RM12 | $CR = \frac{1}{4}$ | d = 1 | ΔI_{L} = 0 |
| Quad - M2 | $\frac{1}{4} < CR < \frac{2}{5}$ | $d = \frac{4 CR - 1}{1 - CR}$ | $Δ {I}_{L} = \frac{( 2 - 5 CR ) * ( 4 CR - 1 )}{3 ( 1 - CR )}$ |
| Quad - RM23 | $CR = \frac{2}{5}$ | d = 1 | ΔI_{L} = 0 |
| Quad - M3 | $\frac{2}{5} < CR < 1$ | $d = \frac{5 CR - 2}{1 + 2 CR}$ | $Δ {I}_{L} = \frac{( 1 - CR ) * ( 5 CR - 2 )}{1 + 2 CR}$ |
| Buck | 0 < CR < 1 | d = CR | ΔI_{L} = CR(1 − CR) |

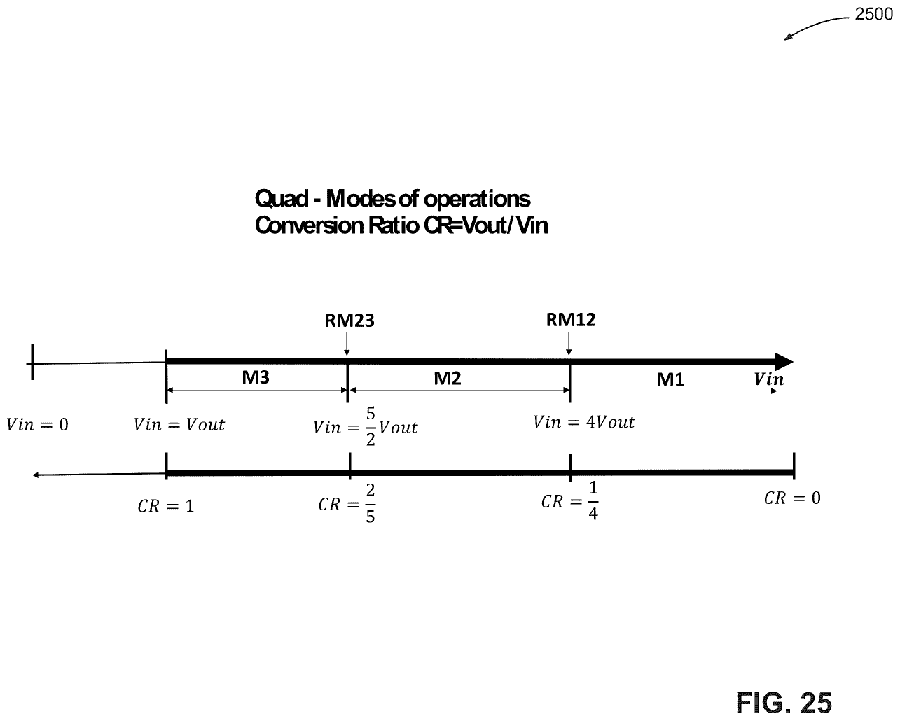

FIG. 25 is a graphical representation 2500 of different possible modes of operation associated with hybrid DC-DC conversion. Graphical representation 2500 shows modes M1, M2 and M3, for different conversion ratios. The resonant modes RM12 and RM 23 occur at the transitions between M1 and M2, and M2 and M3, respectively (and vice versa).

FIG. 26 is a graph 2600 of duty cycle versus conversion ratio for different modes of operation of the hybrid DC-DC converters described herein. Graph 2600 is a representation of the set of equations from Table 8, third column. Graph 2600 combines different plots, specific to a limited range of Vᵢₙ into a unique plot. For such limited ranges of Vᵢₙ, different modes of operation have been presented. The labels Quad M1, Quad M2, and Quad M3 are based on these different modes of operation. A circuit performing such a conversion for a full range of Vᵢₙ is presented in FIG. 20 (i.e., hybrid DC-DC converter 2000). For the sake of comparison, a plot of a buck converter is also included in graph 2600.

FIG. 27 is a graph 2700 of normalized inductor ripple current versus conversion ratio for the hybrid DC-DC converters described herein. Graph 2700 includes a plot for each of the Quad M1, Quad M2, and Quad M3 hybrid DC-DC converter modes presented herein, and implemented by the hybrid DC-DC converters described herein. For the sake of comparison, a plot of a buck converter is also included in graph 2700.

The systems and methods described and equations presented herein are related to the hybrid DC-DC converters described herein. These equations (and graphs) are specific to these hybrid DC-DC converters, and are a direct result of the unique switching sequences that have been implemented.

FIG. 28 is a circuit diagram of a hybrid DC-DC converter 2800. The operational modes and associated circuits discussed above cover a full range of input voltage Vᵢₙ: From minimum Vₒᵤₜ up to more than 4Vₒᵤₜ. For even higher voltages, the circuits proposed here can work but their performance will either start to degrade or the costs will be prohibitive.

Hybrid DC-DC converter 2800 is obtained by scaling up the circuit topology for hybrid DC-DC converter 700. The voltages in hybrid DC-DC converter 700 can be scaled up to an input voltage Vᵢₙ≥n*Vₒᵤₜ in hybrid DC-DC converter 2800, while maintaining the advantages presented here in terms of efficiency and cost. In an aspect, hybrid DC-DC converter is referred to as an “n-Level Current Path Hybrid Converter”, because it allows efficient power conversion from Vᵢₙ to Vₒᵤₜ, keeping LX node voltage (V_{LX}) down to (Vᵢₙ−Vₒᵤₜ)/n and allowing n−1 currents path going through the inductor, and 1 current path going directly into the output (Vₒᵤₜ) node.

In an aspect, hybrid DC−DC converter includes 2n-2 flying capacitors and 4n switching transistors (e.g., FETs). The pre-bias voltages on flying capacitors are:

$$\begin{matrix}{V}_{C 1} = \frac{( n - 2 ) * Vin + Vout}{n - 1} & on C 1 \\ {V}_{C 2} = \frac{( n - 3 ) * Vin + 2 Vout}{n - 1} & on C 2 \\ {V}_{C ( n - 2 )} = \frac{Vin + ( n - 2 ) * Vout}{n - 1} & on C ( n - 2 ) \\ {V}_{C ( n - 1 )} = Vout & on C ( n - 1 )\end{matrix}$$

For n=4, the circuit topology of hybrid DC-DC converter 2800 reduces to that of hybrid DC-DC converter 700.

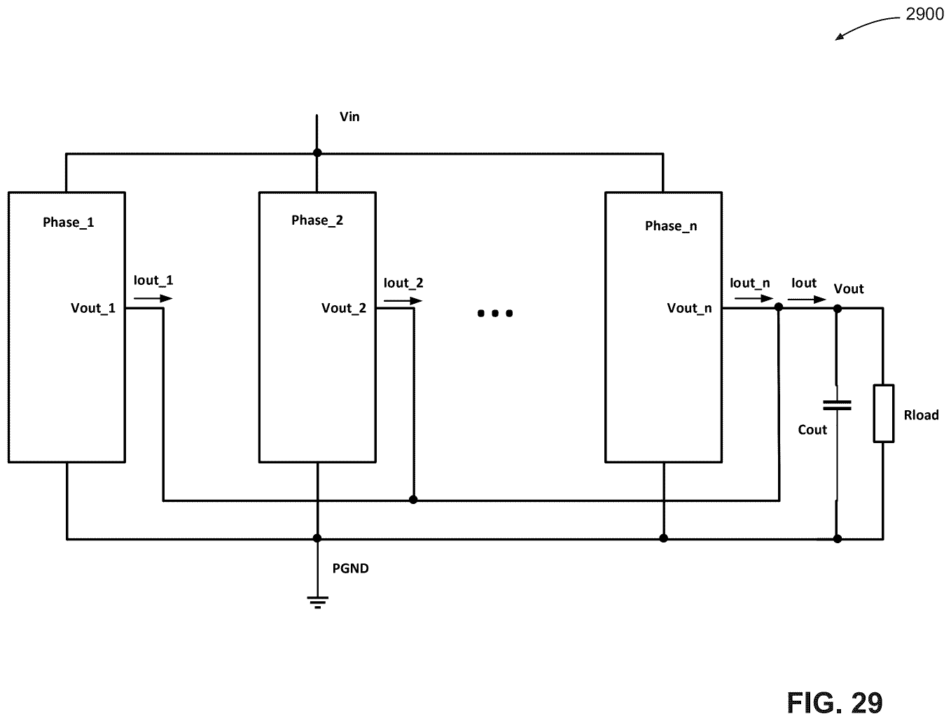

FIG. 29 is a block diagram depicting a multiphase DC-DC conversion operation 2900. In an aspect, multiphase DC-DC conversion operation 2900 can be used for high output current needed by, for example, an AI chip. A high-current delivery system can be achieved by connecting in parallel as many phases of hybrid DC-DC converters as needed, as depicted in FIG. 29. Such a multi-phase system has the same input Vᵢₙ and the same output Vₒᵤₜ. Each phase can be any of hybrid DC-DC converters 100, 700, 900, 1200, 1700, 2000, or 2800. Each phase will generate current Iₒᵤₜ_{₁}, Iₒᵤₜ_{₂} . . . Iₒᵤₜ_{ₙ} respectively. The total output current is

$${I}_{out} = {I}_{{out}_{1}} + {I}_{{out}_{2}} … + {I}_{{out}_{n}} .$$

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. An electrical circuit configured to perform a DC-DC voltage conversion between an input voltage Vᵢₙ and an output voltage Vₒᵤₜ, the electrical circuit comprising:
a first electrical network connected between an input node associated with the input voltage and an output node associated with the output voltage, the first electrical network including eight switching transistors, wherein six of the eight switching transistors are cross-coupled;
a second electrical network connected between a switching node and a ground node;
six flying capacitors connected between the first electrical network and the second electrical network; and
an inductor connected between the switching node and the output node, wherein the DC-DC voltage conversion involves a repeated cycle of four distinct switching system states, and wherein each switching system state is associated with a distinct electric current path through the electrical circuit.

2. The electrical circuit of claim 1, wherein:
there exists a direct path for an electric current between the input node and the output node, wherein the direct path includes only one or more of the switching transistors;
the electric current passes through at least one switching transistor;
any electric current path between the switching node and the input node includes at least one flying capacitor of the flying capacitors; and
there is at least one switching transistor connected to the output node.

3. The electrical circuit of claim 2, wherein an electric current flowing through the inductor bypasses the at least one switching transistor connected directly to the output node in at least one of the switching system states.

4. The electrical circuit of claim 1, wherein electrical circuit is of a symmetrical configuration.

5. The electrical circuit of claim 1, wherein the four distinct switching system states are comprised of a first magnetization system state, a demagnetization system state, a second magnetization system state, and the demagnetization system state.

6. The electrical circuit of claim 1, wherein the electrical circuit supports a mode of operation that is one of two modes of operation:
a first mode, wherein the output voltage and the input voltage are related by an inequality 4Vₒᵤₜ<Vᵢₙ; and
a resonant mode, wherein the output voltage and the input voltage are related by an equality 4Vₒᵤₜ=Vᵢₙ.

7. The electrical circuit of claim 6, wherein a respective pre-bias voltage of each flying capacitor is independent of the mode of operation.

8. The electrical circuit of claim 1, wherein there exist four distinct current paths for an electric current flowing through the electrical circuit, and wherein at least one current path enables a corresponding electric current to flow directly to the output node while bypassing the inductor.

9. The electrical circuit of claim 1, wherein the flying capacitors are configured to be pre-charged at respective preset voltage levels.

10. The electrical circuit of claim 1, wherein at least one electric current path includes the electric current flowing through the first electrical network, the second electrical network, and the inductor.

11. The electrical circuit of claim 1, wherein the second electrical network comprises four switching transistors, wherein each system state is associated with a combination of each of the eight switching transistors in the first electrical network and each of the four switching transistors in the second electrical network being in an on state or an off state.

12. The electrical circuit of claim 11, wherein each flying capacitor connects a transistor terminal connection node in the first electrical network and a transistor terminal connection node in the second electrical network.

13. The electrical circuit of claim 12, wherein:
a first flying capacitor of the flying capacitors connects a transistor terminal connection node between switching transistors Q1 and Q2 in the first electrical network to a transistor terminal connection node between switching transistors Q5 and Q6 in the second electrical network;
a second flying capacitor of the flying capacitors connects a transistor terminal connection node between switching transistors Q3 and Q8 in the first electrical network to a transistor terminal connection node between switching transistors Q5 and Q6 in the second electrical network;
a third flying capacitor of the flying capacitors connects a transistor terminal connection node between switching transistors Q4 and Q9 in the first electrical network to a transistor terminal connection node between switching transistors Q5 and Q6 in the second electrical network;
a fourth flying capacitor of the flying capacitors connects a transistor terminal connection node between switching transistors Q7 and Q8 in the first electrical network to a transistor terminal connection node between switching transistors Q11 and Q12 in the second electrical network;
a fifth flying capacitor of the flying capacitors connects a transistor terminal connection node between switching transistors Q2 and Q9 in the first electrical network to a transistor terminal connection node between switching transistors Q11 and Q12 in the second electrical network; and
a sixth flying capacitor of the flying capacitors connects a transistor terminal connection node between switching transistors Q3 and Q10 in the first electrical network to a transistor terminal connection node between switching transistors Q11 and Q12 in the second electrical network.

14. The electrical circuit of claim 13, wherein:
a preset voltage on each of the first and fourth flying capacitors is
$$\frac{2 {V}_{in} + {V}_{out}}{3} ;$$
a preset voltage on each of the second and fifth flying capacitors is
$$\frac{{V}_{in} + 2 {V}_{out}}{3} ;$$
and
a preset voltage on each of the third and sixth flying capacitors is Vₒᵤₜ.

15. The electrical circuit of claim 11, further comprising an additional four switching transistors included in the lower electrical network in a symmetrical configuration to provide a modified electrical circuit.

16. The electrical circuit of claim 15, wherein the modified electrical circuit supports a mode of operation wherein the output voltage and the input voltage are related by an inequality
$$\frac{5}{2} {V}_{out} < {V}_{in} < 4 {V}_{out}$$
in this mode.

17. The electrical circuit of claim 15, wherein the four distinct switching cycles of the modified electrical circuit are comprised of a first magnetization system state, a first demagnetization system state, a second magnetization system state, and a second demagnetization system state.

18. The electrical circuit of claim 15, wherein each flying capacitor connects a transistor terminal connection node in the first electrical network and a transistor terminal connection node in the second electrical network.

19. The electrical circuit of claim 18, wherein:
a first flying capacitor of the flying capacitors connects a transistor terminal connection node between switching transistors Q1 and Q2 in the first electrical network to a transistor terminal connection node between switching transistors Q13 and Q14 in the second electrical network;
a second flying capacitor of the flying capacitors connects a transistor terminal connection node between switching transistors Q3 and Q8 in the first electrical network to a transistor terminal connection node between switching transistors Q6 and Q13 in the second electrical network;
a third flying capacitor of the flying capacitors connects a transistor terminal connection node between switching transistors Q4 and Q9 in the first electrical network to a transistor terminal connection node between switching transistors Q5 and Q6 in the second electrical network;
a fourth flying capacitor of the flying capacitors connects a transistor terminal connection node between switching transistors Q7 and Q8 in the first electrical network to a transistor terminal connection node between switching transistors Q15 and Q16 in the second electrical network;
a fifth flying capacitor of the flying capacitors connects a transistor terminal connection node between switching transistors Q2 and Q9 in the first electrical network to a transistor terminal connection node between switching transistors Q12 and Q15 in the second electrical network; and
a sixth flying capacitor of the flying capacitors connects a transistor terminal connection node between switching transistors Q3 and Q10 in the first electrical network to a transistor terminal connection node between switching transistors Q11 and Q12 in the second electrical network.

20. The electrical circuit of claim 19, wherein:
a preset voltage on each of the first and fourth flying capacitors is
$$\frac{2 {V}_{in} + {V}_{out}}{3} ;$$
a preset voltage on each of the second and fifth flying capacitors is
$$\frac{{V}_{in} + 2 {V}_{out}}{3} ;$$
and
a preset voltage on each of the third and sixth flying capacitors is Vₒᵤₜ.

21. The electrical circuit of claim 19, wherein switching transistors Q6 and Q12 are replaced by electrical wires, thereby enabling switching transistors Q5 and Q13 to be directly connected at a transistor terminal connection node, and switching transistors Q11 and Q15 to be directly connected at a transistor terminal connection node, for a total of six switching transistors in the second electrical network.

22. The electrical circuit of claim 21, wherein two additional switching transistors are included in the first electrical network in a symmetrical configuration to provide a further modified electrical circuit.

23. The electrical circuit of claim 22, wherein the further modified electrical circuit supports a mode of operation wherein the output voltage and the input voltage are related by an inequality
$${V}_{out} < {V}_{in} < \frac{5}{2} {V}_{out}$$
in this mode.

24. The electrical circuit of claim 1, further comprising an additional four switching transistors in the second electrical network in a symmetrical configuration, to provide a modified electrical circuit.

25. The electrical circuit of claim 24, wherein the modified electrical circuit supports a resonant mode of operation wherein the output voltage and the input voltage are related by an inequality
$${V}_{in} = \frac{5}{2} {V}_{out}$$
in this mode.
